(19) United States
(12) Patent Application Publication
(10) Pub. No.: US 2026/0211221 A1
(43) Pub. Date: Jul. 23, 2026

(54) IMAGING OPTICAL SYSTEM, AND IMAGE CAPTURE DEVICE AND CAMERA SYSTEM INCLUDING THE SAME

(71) Applicant: Panasonic Intellectual Property Management Co., Ltd., Osaka (JP)

(72) Inventors: Takehiro NISHIOKA, Nara (JP); Yuka Ikegami, Hyogo (JP)

(21) Appl. No.: 19/450,206

(22) Filed: Jan. 15, 2026

(30) Foreign Application Priority Data
Jan. 17, 2025 (JP) 2025-006562

(51) Int. Cl. G02B 15/14; G02B 7/14; G03B 5/00; H04N 23/63

(52) U.S. Cl. CPC G02B 15/1461; G02B 7/14; G03B 5/00; H04N 23/63; G03B 2205/0007

(57) ABSTRACT

An imaging optical system consists of: a first lens group having positive power; a second lens group having negative power; a third lens group having positive power; a fourth lens group having positive power; a fifth lens group having negative power; a sixth lens group having positive power; and a seventh lens group having negative power. The first through seventh lens groups are arranged in this order such that the first lens group is located closest to an object and that the seventh lens group is located closest to an image plane. An interval between each pair of lens groups located adjacent to each other which belong to the first through seventh lens groups changes while the imaging optical system is zooming from a wide-angle end toward a telephoto end. The second lens group and the sixth lens group are fixed with respect to the image plane.

### CROSS-REFERENCE TO RELATED APPLICATIONS

The present application is based on, and claims the benefit of priority to, Japanese Patent Application No. 2025-006562, filed on Jan. 17, 2025, the entire contents of which are hereby incorporated by reference.

### TECHNICAL FIELD

The present disclosure relates to an imaging optical system having the ability to compensate for various types of aberrations sufficiently over the entire zoom range and also relates to an image capture device and camera system including such an imaging optical system.

### BACKGROUND ART

JP 2021-056407 A discloses a zoom lens consisting of: a first lens group having positive refractive power; a second lens group having negative refractive power; a third lens group having positive refractive power; a middle group including multiple lens groups; and a last lens group having negative refractive power. All of these lens groups are arranged in this order such that the first lens group is located closer to the object than any of the other lens groups is and that the last lens group is located closer to the image plane than any of the other lens groups is. The zoom lens includes an aperture stop. The interval between adjacent lens groups changes while the zoom lens is zooming. The middle group includes a negative lens group having negative refractive power. While the zoom lens is zooming from the wide-angle end toward the telephoto end, the negative lens group and the last lens group move along with each other toward the object.

### SUMMARY

The present disclosure provides an imaging optical system having the ability to compensate for various types of aberrations sufficiently over the entire zoom range and an image capture device and camera system including such an imaging optical system.

An imaging optical system according to an aspect of the present disclosure consists of: a first lens group having positive power; a second lens group having negative power; a third lens group having positive power; a fourth lens group having positive power; a fifth lens group having negative power; a sixth lens group having positive power; and a seventh lens group having negative power. The first, second, third, fourth, fifth, sixth, and seventh lens groups are arranged in this order such that the first lens group is located closer to an object than any of the second, third, fourth, fifth, sixth, or seventh lens group is and that the seventh lens group is located closer to an image plane than any of the first, second, third, fourth, fifth, or sixth lens groups is. An interval between each pair of lens groups located adjacent to each other which belong to the first through seventh lens groups changes while the imaging optical system is zooming from a wide-angle end toward a telephoto end. The second lens group and the sixth lens group are fixed with respect to the image plane.

An image capture device according to another aspect of the present disclosure is configured to transform an optical image of an object into an electrical image signal and display and/or store the electrical image signal thus transformed. The image capture device includes: the imaging optical system configured to form the optical image of the object; and an image sensor configured to transform the optical image formed by the imaging optical system into the electrical image signal.

A camera system according to still another aspect of the present disclosure includes: an interchangeable lens unit including the imaging optical system described above; and a camera body including: an image sensor configured to receive an optical image of an object formed by the imaging optical system and transform the optical image into an electrical image signal; and a camera mount. The camera body is configured to be connected removably to the interchangeable lens unit via the camera mount. The interchangeable lens unit is configured to form the optical image of the object on the image sensor.

### BRIEF DESCRIPTION OF DRAWINGS

The figures depict one or more implementations in accordance with the present teaching, by way of example only, not by way of limitations. In the figures, like reference numerals refer to the same or similar elements.

FIG. 1A illustrates lens arrangements showing an infinity in-focus state of an imaging optical system according to a first embodiment (corresponding to a first example of numerical values);

FIG. 1B illustrates longitudinal aberration diagrams showing the infinity in-focus state of the imaging optical system in the first example of numerical values;

FIG. 1C illustrates lateral aberration diagrams showing a basic state where the imaging optical system is making no image blur compensation and an image blur compensated state where the imaging optical system is making image blur compensation, respectively, at a telephoto end in the first example of numerical values;

FIG. 2A illustrates lens arrangements showing an infinity in-focus state of an imaging optical system according to a second embodiment (corresponding to a second example of numerical values);

FIG. 2B illustrates longitudinal aberration diagrams showing the infinity in-focus state of the imaging optical system in the second example of numerical values;

FIG. 2C illustrates lateral aberration diagrams showing a basic state where the imaging optical system is making no image blur compensation and an image blur compensated state where the imaging optical system is making image blur compensation, respectively, at a telephoto end in the second example of numerical values;

FIG. 3A illustrates lens arrangements showing an infinity in-focus state of an imaging optical system according to a third embodiment (corresponding to a third example of numerical values);

FIG. 3B illustrates longitudinal aberration diagrams showing the infinity in-focus state of the imaging optical system in the third example of numerical values;

FIG. 3C illustrates lateral aberration diagrams showing a basic state where the imaging optical system is making no image blur compensation and an image blur compensated state where the imaging optical system is making image blur compensation, respectively, at a telephoto end in the third example of numerical values;

FIG. 4A illustrates lens arrangements showing an infinity in-focus state of an imaging optical system according to a fourth embodiment (corresponding to a fourth example of numerical values);

FIG. 4B illustrates longitudinal aberration diagrams showing the infinity in-focus state of the imaging optical system in the fourth example of numerical values;

FIG. 4C illustrates lateral aberration diagrams showing a basic state where the imaging optical system is making no image blur compensation and an image blur compensated state where the imaging optical system is making image blur compensation, respectively, at a telephoto end in the fourth example of numerical values;

FIG. 5A illustrates lens arrangements showing an infinity in-focus state of an imaging optical system according to a fifth embodiment (corresponding to a fifth example of numerical values);

FIG. 5B illustrates longitudinal aberration diagrams showing the infinity in-focus state of the imaging optical system in the fifth example of numerical values;

FIG. 5C illustrates lateral aberration diagrams showing a basic state where the imaging optical system is making no image blur compensation and an image blur compensated state where the imaging optical system is making image blur compensation, respectively, at a telephoto end in the fifth example of numerical values;

FIG. 6A illustrates lens arrangements showing an infinity in-focus state of an imaging optical system according to a sixth embodiment (corresponding to a sixth example of numerical values);

FIG. 6B illustrates longitudinal aberration diagrams showing the infinity in-focus state of the imaging optical system in the sixth example of numerical values;

FIG. 6C illustrates lateral aberration diagrams showing a basic state where the imaging optical system is making no image blur compensation and an image blur compensated state where the imaging optical system is making image blur compensation, respectively, at a telephoto end in the sixth example of numerical values;

FIG. 7A illustrates lens arrangements showing an infinity in-focus state of an imaging optical system according to a seventh embodiment (corresponding to a seventh example of numerical values);

FIG. 7B illustrates longitudinal aberration diagrams showing the infinity in-focus state of the imaging optical system in the seventh example of numerical values;

FIG. 7C illustrates lateral aberration diagrams showing a basic state where the imaging optical system is making no image blur compensation and an image blur compensated state where the imaging optical system is making image blur compensation, respectively, at a telephoto end in the seventh example of numerical values;

FIG. 8 illustrates a schematic configuration for an image capture device according to the first embodiment; and

FIG. 9 illustrates a schematic configuration for a camera system according to the first embodiment.

### DETAILED DESCRIPTION

Embodiments of the present disclosure will now be described in detail with reference to the accompanying drawings as needed. Note that unnecessarily detailed description will be omitted. For example, detailed description of already well-known matters and redundant description of substantially the same configuration will be omitted. This is done to avoid making the following description overly redundant and thereby help one of ordinary skill in the art understand the present disclosure easily.

In addition, note that the accompanying drawings and the following description are provided to help one of ordinary skill in the art understand the present disclosure fully and should not be construed as limiting the scope of the present disclosure, which is defined by the appended claims.

### First to Seventh Embodiments

Imaging optical systems according to first to seventh embodiments will now be described on an individual basis with reference to the accompanying drawings.

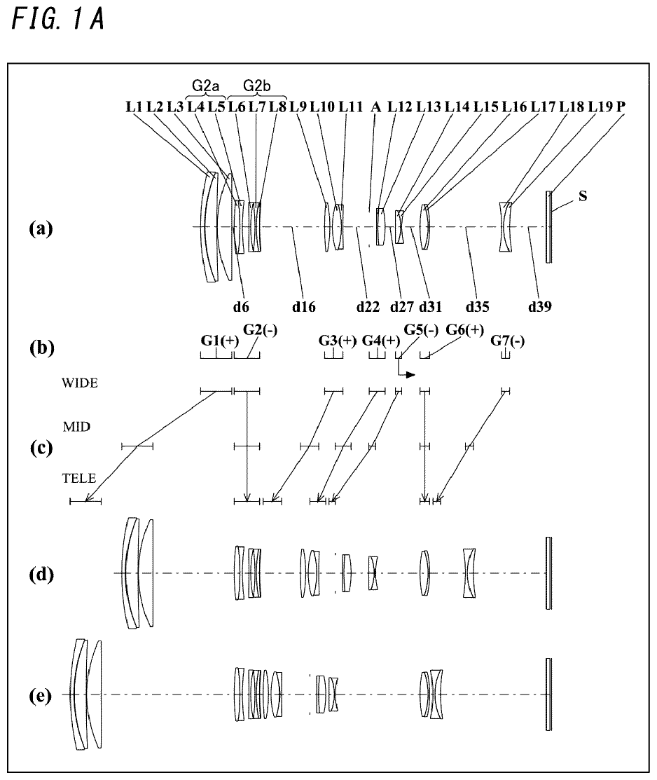

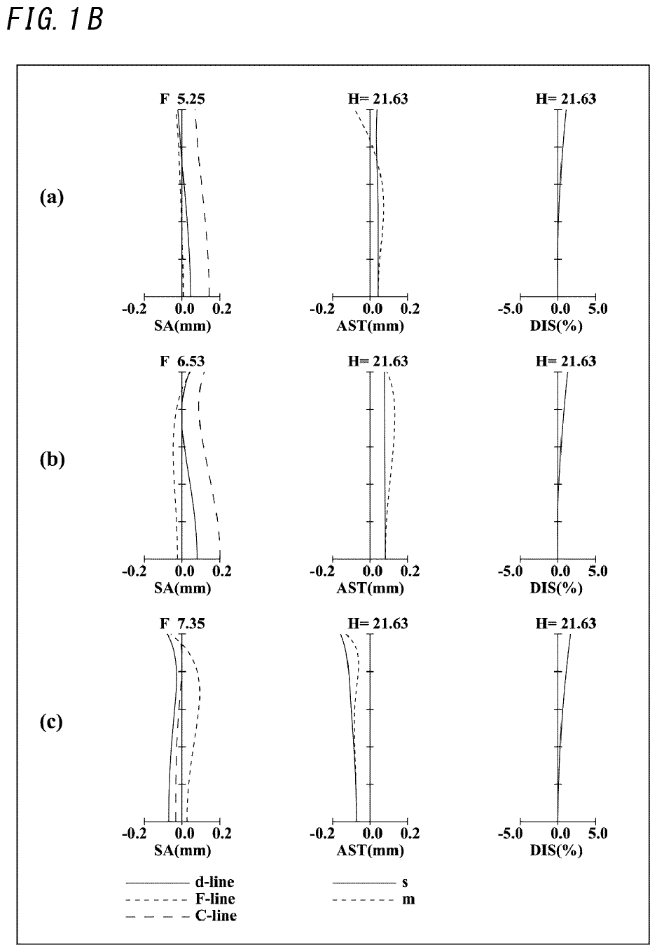

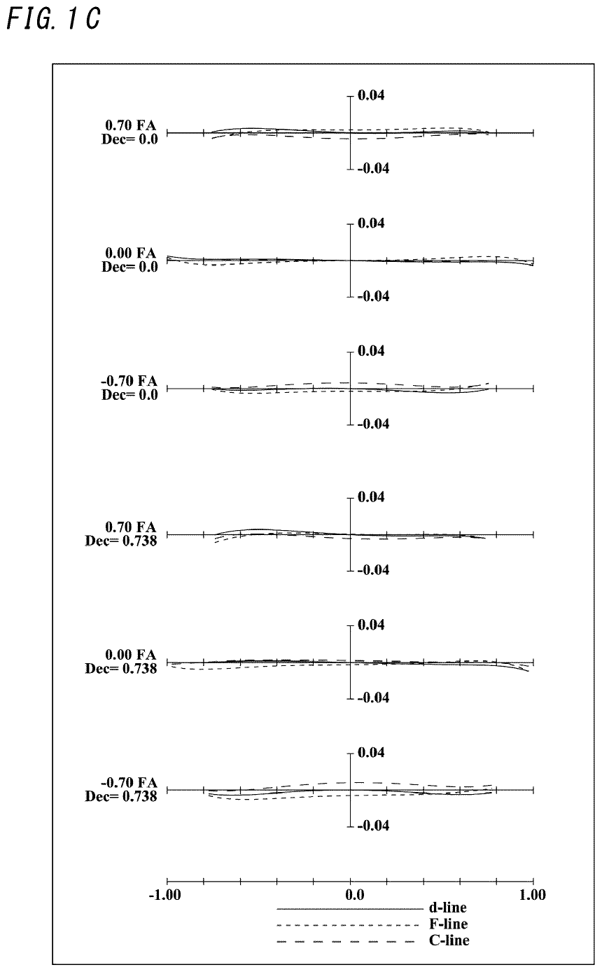

FIGS. 1A, 2A, 3A, 4A, 5A, 6A, and 7A illustrate lens arrangements of imaging optical systems according to first to seventh embodiments, respectively. In each of FIGS. 1A, 2A, 3A, 4A, 5A, 6A, and 7A, the imaging optical system is in an infinity in-focus state.

In FIGS. 1A, 2A, 3A, 4A, 5A, 6A, and 7A, portion (a) illustrates a lens arrangement at a wide-angle end (which is a state with the shortest focal length fW); portion (d) illustrates a lens arrangement at a middle position (which is a state with a middle focal length fM=√(fW*fT)); and portion (e) illustrates a lens arrangement at a telephoto end (which is a state with the longest focal length fT). Note that portions (a), (d), and (e) of FIGS. 1A, 2A, 3A, 4A, 5A, 6A, and 7A have the same aspect ratio.

Furthermore, in portion (a) of FIGS. 1A, 2A, 3A, 4A, 5A, 6A, and 7A, the asterisk (*) attached to a surface of a particular lens indicates that the surface is an aspheric surface. Note that in the lenses shown in portion (a) of FIGS. 1A, 2A, 3A, 4A, 5A, 6A, and 7A, an object-side surface or an image-side surface having no asterisks (*) is a spherical surface.

Also, in FIGS. 1A, 2A, 3A, 4A, 5A, 6A, and 7A, the polygon arrows shown in portion (c) thereof each connect together the respective positions of the lens groups at the wide-angle end (WIDE), middle position (MID), and telephoto end (TELE) from top to bottom. Note that these polygon arrows just connect the wide-angle end to the middle position and the middle position to the telephoto end with the lines, and do not indicate the actual movement of the lens groups.

Furthermore, in portion (b) of FIGS. 1A, 2A, 3A, 4A, 5A, 6A, and 7A, the respective lens groups are designated by the reference signs G1-G7 corresponding to their respective positions shown in portion (a).

Furthermore, the signs (+) and (−) added to the reference signs G1-G7 of the respective lens groups in portion (b) of FIGS. 1A, 2A, 3A, 4A, 5A, 6A, and 7A indicate the powers of the respective lens groups G1-G7. That is to say, the positive sign (+) indicates positive power, and the negative sign (−) indicates negative power.

Also, the arrows added to the lens groups in portion (b) of FIGS. 1A, 2A, 3A, 4A, 5A, 6A, and 7A, each indicate focusing to make a transition from the infinity in-focus state toward the close-object in-focus state. Note that in FIGS. 1A, 2A, 3A, 4A, 5A, 6A, and 7A, the reference signs of respective lens groups are shown under the respective lens groups in portion (a) thereof, and therefore, an arrow indicating focusing is shown under the sign of each lens group for convenience's sake. In each zooming state, the directions of movement of the respective lens groups during focusing will be described more specifically later with respect to each of the first through seventh embodiments.

Furthermore, in portions (a), (d), and (e) of FIGS. 1A, 2A, 3A, 4A, 5A, 6A, and 7A, the straight line drawn at the right end indicates the position of the image plane S (i.e., a surface, facing the object, of the image sensor). Therefore, the left end of the drawings corresponds to the object side. Furthermore, a parallel plate P such as a low-pass filter or cover glass is disposed between the lens group on the last stage, facing the image plane S, of the imaging optical system and the image plane S.

### First Embodiment

FIG. 1A illustrates an imaging optical system according to a first embodiment.

The imaging optical system includes: a first lens group G1 having positive power; a second lens group G2 having negative power; a third lens group G3 having positive power; a fourth lens group G4 having positive power; a fifth lens group G5 having negative power; a sixth lens group G6 having positive power; and a seventh lens group G7 having negative power. The first, second, third, fourth, fifth, sixth, and seventh lens groups G1, G2, G3, G4, G5, G6, G7 are arranged in this order such that the first lens group G1 is located closer to an object than any of the second, third, fourth, fifth, sixth or seventh lens group G2, G3, G4, G5, G6, G7 is and that the seventh lens group G7 is located closer to an image plane than any of the first, second, third, fourth, fifth, or sixth lens group G1, G2, G3, G4, G5, G6 is.

The imaging optical system forms an image at a point on the image plane S.

The respective lens groups will be described one by one.

The first lens group G1 is made up of: a first lens L1 having negative power; a second lens L2 having positive power; and a third lens L3 having positive power. The first lens L1, the second lens L2, and the third lens L3 are arranged in this order such that the first lens L1 is located closer to the object than any other member of this first lens group G1 is and that the third lens L3 is located closer to the image plane than any other member of this first lens group G1 is.

The second lens group G2 is made up of a sub-lens group G2a having negative power and a sub-lens group G2b having negative power. The sub-lens group G2a and the sub-lens group G2b are arranged in this order such that the sub-lens group G2a is located closer to the object than the sub-lens group G2b is and that the sub-lens group G2b is located closer to the image plane than the sub-lens group G2a is.

The third lens group G3 is made up of: a ninth lens L9 having positive power; a tenth lens L10 having positive power; and an eleventh lens L11 having negative power. The ninth lens L9, the tenth lens L10, and the eleventh lens L11 are arranged in this order such that the ninth lens L9 is located closer to the object than any other member of this third lens group G3 is and that the eleventh lens L11 is located closer to the image plane than any other member of this third lens group G3 is. The tenth lens L10 and the eleventh lens L11 are bonded together with an adhesive, for example, to form a bonded lens. That is to say, the bonded lens includes the tenth lens L10 and the eleventh lens L11.

The fourth lens group G4 is made up of: an aperture stop A; a twelfth lens L12 having negative power; and a thirteenth lens L13 having positive power. The aperture stop A and the twelfth and thirteenth lenses L12, L13 are arranged in this order such that the aperture stop A is located closer to the object than any other member of this fourth lens group G4 is and that the thirteenth lens L13 is located closer to the image plane than any other member of this fourth lens group G4 is. The twelfth lens L12 and the thirteenth lens L13 are bonded together with an adhesive, for example, to form a bonded lens. That is to say, the bonded lens includes the twelfth lens L12 and the thirteenth lens L13.

The fifth lens group G5 is made up of a fourteenth lens L14 having positive power and a fifteenth lens L15 having negative power. The fourteenth and fifteenth lenses L14, L15 are arranged in this order such that the fourteenth lens L14 is located closer to the object than the fifteenth lens L15 is and that the fifteenth lens L15 is located closer to the image plane than the fourteenth lens L14 is. The fourteenth lens L14 and the fifteenth lens L15 are bonded together with an adhesive, for example, to form a bonded lens. That is to say, the bonded lens includes the fourteenth lens L14 and the fifteenth lens L15.

The sixth lens group G6 is made up of a sixteenth lens L16 having positive power and a seventeenth lens L17 having negative power. The sixteenth and seventeenth lenses L16, L17 are arranged in this order such that the sixteenth lens L16 is located closer to the object than the seventeenth lens L17 is and that the seventeenth lens L17 is located closer to the image plane than the sixteenth lens L16 is. The sixteenth lens L16 and the seventeenth lens L17 are bonded together with an adhesive, for example, to form a bonded lens. That is to say, the bonded lens includes the sixteenth lens L16 and the seventeenth lens L17.

The seventh lens group G7 is made up of an eighteenth lens L18 having negative power and a nineteenth lens L19 having positive power. The eighteenth and nineteenth lenses L18, L19 are arranged in this order such that the eighteenth lens L18 is located closer to the object than the nineteenth lens L19 is and that the nineteenth lens L19 is located closer to the image plane than the eighteenth lens L18 is. The eighteenth lens L18 and the nineteenth lens L19 are bonded together with an adhesive, for example, to form a bonded lens. That is to say, the bonded lens includes the eighteenth lens L18 and the nineteenth lens L19.

The respective sub-lens groups will be described.

The sub-lens group G2a is made up of a fourth lens L4 having positive power and a fifth lens L5 having negative power. The fourth lens L4 and the fifth lens L5 are arranged in this order such that the fourth lens L4 is located closer to the object than the fifth lens L5 is and that the fifth lens L5 is located closer to the image plane than the fourth lens L4 is. The fourth lens L4 and the fifth lens L5 are bonded together with an adhesive, for example, to form a bonded lens. That is to say, the bonded lens includes the fourth lens L4 and the fifth lens L5.

The sub-lens group G2b is made up of a sixth lens L6 having negative power, a seventh lens L7 having negative power, and an eighth lens L8 having positive power. The sixth, seventh, and eighth lenses L6, L7, L8 are arranged in this order such that the sixth lens L6 is located closer to the object than the seventh lens L7 or the eighth lens L8 is and that the eighth lens L8 is located closer to the image plane than the sixth lens L6 or the seventh lens L7 is. The seventh lens L7 and the eighth lens L8 are bonded together with an adhesive, for example, to form a bonded lens. That is to say, the bonded lens includes the seventh lens L7 and the eighth lens L8.

The respective lenses will be described one by one.

First, the respective lenses that form the first lens group G1 will be described. The first lens L1 is a meniscus lens having a convex surface facing the object. The second lens L2 is a meniscus lens having a convex surface facing the object. The third lens L3 is a plano-convex lens having a convex surface facing the object.

Next, the respective lenses that form the second lens group G2 will be described. The fourth lens L4 is a biconvex lens. The fifth lens L5 is a biconcave lens. The sixth lens L6 is a biconcave lens. The seventh lens L7 is a biconcave lens. The eighth lens L8 is a meniscus lens having a convex surface facing the object.

Next, the respective lenses that form the third lens group G3 will be described. The ninth lens L9 is a biconvex lens. The tenth lens L10 is a biconvex lens. The eleventh lens L11 is a biconcave lens.

Next, the respective lenses that form the fourth lens group G4 will be described. The twelfth lens L12 is a biconcave lens. The thirteenth lens L13 is a biconvex lens.

Next, the respective lenses that form the fifth lens group G5 will be described. The fourteenth lens L14 is a biconvex lens. The fifteenth lens L15 is a biconcave lens.

Next, the respective lenses that form the sixth lens group G6 will be described. The sixteenth lens L16 is a biconvex lens. The seventeenth lens L17 is a meniscus lens having a convex surface facing the image plane.

Next, the respective lenses that form the seventh lens group G7 will be described. The eighteenth lens L18 is a biconcave lens. The nineteenth lens L19 is a meniscus lens having a convex surface facing the object.

While the imaging optical system according to the first embodiment is zooming from the wide-angle end toward the telephoto end during a shooting session, the first lens group G1, the third lens group G3, the fourth lens group G4, the fifth lens group G5, and the seventh lens group G7 all move toward the object with respect to the image plane S. In the meantime, as the imaging optical system is zooming from the wide-angle end toward the telephoto end during the shooting session, the first, third, fourth, fifth, and seventh lens groups G1, G3, G4, G5, G7 move along the optical axis such that the interval between the first lens group G1 and the second lens group G2 increases, the interval between the second lens group G2 and the third lens group G3 decreases, the interval between the third lens group G3 and the fourth lens group G4 decreases and then increases, the interval between the fourth lens group G4 and the fifth lens group G5 increases and then decreases, the interval between the fifth lens group G5 and the sixth lens group G6 increases, the interval between the sixth lens group G6 and the seventh lens group G7 decreases, and the interval between the seventh lens group G7 and the image plane S increases.

While the imaging optical system according to the first embodiment is focusing to make a transition from the infinity in-focus state toward the close-object in-focus state, the fifth lens group G5 moves along the optical axis toward the image plane.

When any camera shake or any vibration caused by external force during a shooting session is detected by a gyrosensor provided for at least one of an interchangeable lens unit holding the imaging optical system or an image capture device to which the interchangeable lens unit is attached, the sub-lens group G2b (forming a group of image stabilizer lenses) which belong to the second lens group G2 moves perpendicularly to the optical axis (i.e., in a direction in which the image blur is reduced) to optically compensate for the image blur that may be caused by the camera shake or the vibration due to external force. These image blur compensation lenses allow the imaging optical system to compensate for the shift of the image point due to the vibration of the overall system. That is to say, this allows the imaging optical system to optically compensate for the image blur due to camera shake, vibrations, and other disturbances.

### Second Embodiment

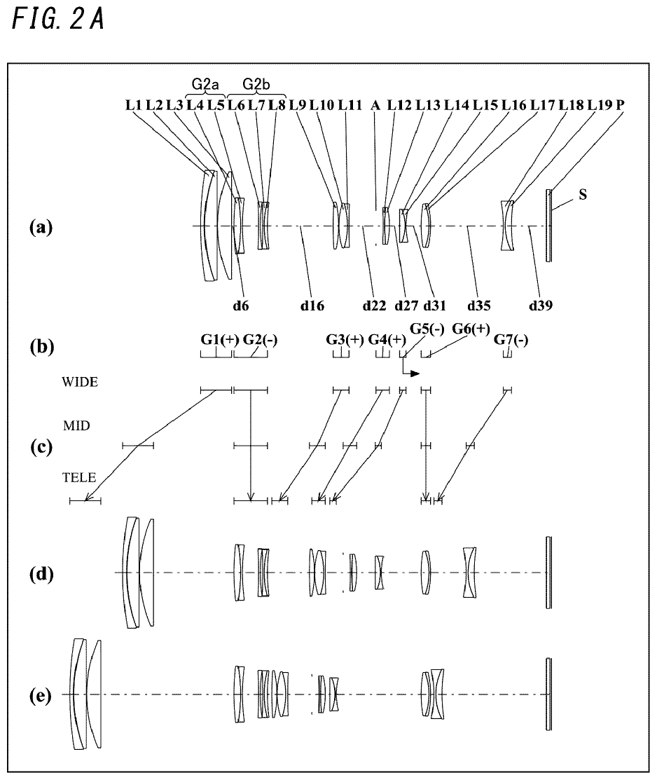

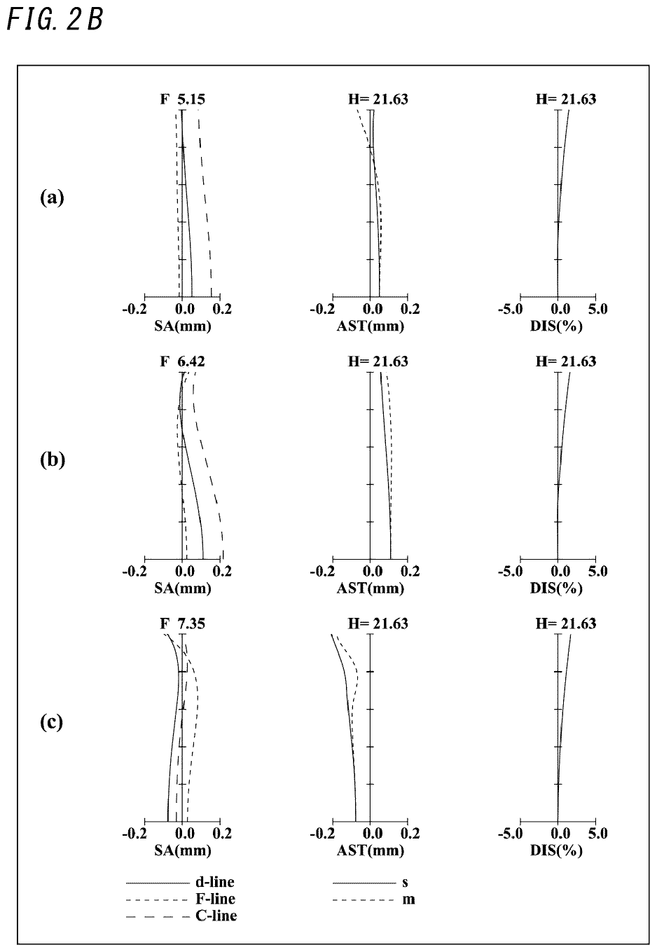

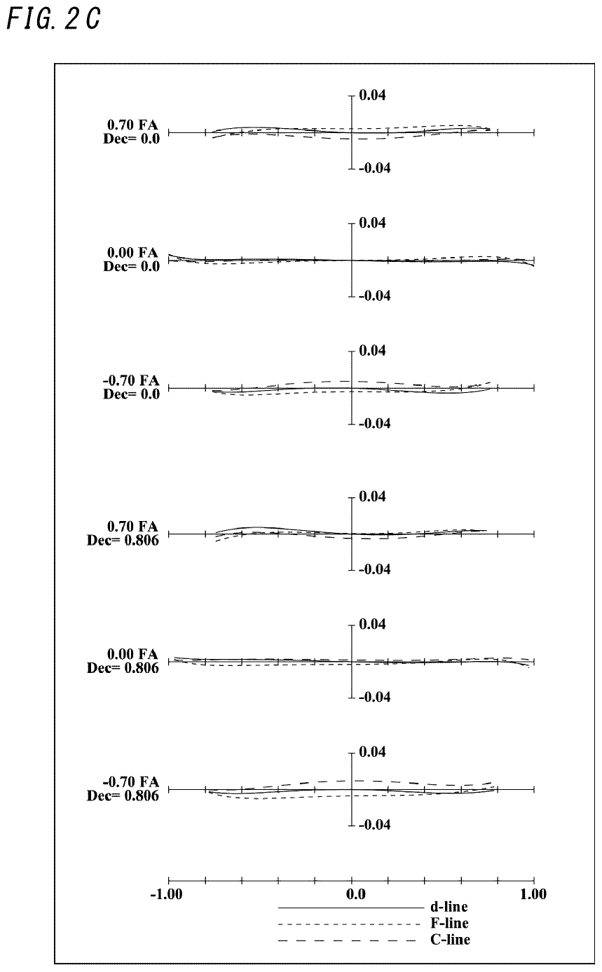

FIG. 2A illustrates an imaging optical system according to a second embodiment.

The imaging optical system includes: a first lens group G1 having positive power; a second lens group G2 having negative power; a third lens group G3 having positive power; a fourth lens group G4 having positive power; a fifth lens group G5 having negative power; a sixth lens group G6 having positive power; and a seventh lens group G7 having negative power. The first, second, third, fourth, fifth, sixth, and seventh lens groups G1, G2, G3, G4, G5, G6, G7 are arranged in this order such that the first lens group G1 is located closer to an object than any of the second, third, fourth, fifth, sixth or seventh lens group G2, G3, G4, G5, G6, G7 is and that the seventh lens group G7 is located closer to an image plane than any of the first, second, third, fourth, fifth, or sixth lens group G1, G2, G3, G4, G5, G6 is.

The imaging optical system forms an image at a point on the image plane S.

The respective lens groups will be described one by one.

The first lens group G1 is made up of: a first lens L1 having negative power; a second lens L2 having positive power; and a third lens L3 having positive power. The first lens L1, the second lens L2, and the third lens L3 are arranged in this order such that the first lens L1 is located closer to the object than any other member of this first lens group G1 is and that the third lens L3 is located closer to the image plane than any other member of this first lens group G1 is.

The second lens group G2 is made up of a sub-lens group G2a having negative power and a sub-lens group G2b having negative power. The sub-lens group G2a and the sub-lens group G2b are arranged in this order such that the sub-lens group G2a is located closer to the object than the sub-lens group G2b is and that the sub-lens group G2b is located closer to the image plane than the sub-lens group G2a is.

The third lens group G3 is made up of: a ninth lens L9 having positive power; a tenth lens L10 having positive power; and an eleventh lens L11 having negative power. The ninth lens L9, the tenth lens L10, and the eleventh lens L11 are arranged in this order such that the ninth lens L9 is located closer to the object than any other member of this third lens group G3 is and that the eleventh lens L11 is located closer to the image plane than any other member of this third lens group G3 is. The tenth lens L10 and the eleventh lens L11 are bonded together with an adhesive, for example, to form a bonded lens. That is to say, the bonded lens includes the tenth lens L10 and the eleventh lens L11.

The fourth lens group G4 is made up of: an aperture stop A; a twelfth lens L12 having negative power; and a thirteenth lens L13 having positive power. The aperture stop A and the twelfth and thirteenth lenses L12, L13 are arranged in this order such that the aperture stop A is located closer to the object than any other member of this fourth lens group G4 is and that the thirteenth lens L13 is located closer to the image plane than any other member of this fourth lens group G4 is. The twelfth lens L12 and the thirteenth lens L13 are bonded together with an adhesive, for example, to form a bonded lens. That is to say, the bonded lens includes the twelfth lens L12 and the thirteenth lens L13.

The fifth lens group G5 is made up of a fourteenth lens L14 having positive power and a fifteenth lens L15 having negative power. The fourteenth and fifteenth lenses L14, L15 are arranged in this order such that the fourteenth lens L14 is located closer to the object than the fifteenth lens L15 is and that the fifteenth lens L15 is located closer to the image plane than the fourteenth lens L14 is. The fourteenth lens L14 and the fifteenth lens L15 are bonded together with an adhesive, for example, to form a bonded lens. That is to say, the bonded lens includes the fourteenth lens L14 and the fifteenth lens L15.

The sixth lens group G6 is made up of a sixteenth lens L16 having positive power and a seventeenth lens L17 having negative power. The sixteenth and seventeenth lenses L16, L17 are arranged in this order such that the sixteenth lens L16 is located closer to the object than the seventeenth lens L17 is and that the seventeenth lens L17 is located closer to the image plane than the sixteenth lens L16 is. The sixteenth lens L16 and the seventeenth lens L17 are bonded together with an adhesive, for example, to form a bonded lens. That is to say, the bonded lens includes the sixteenth lens L16 and the seventeenth lens L17.

The seventh lens group G7 is made up of an eighteenth lens L18 having negative power and a nineteenth lens L19 having positive power. The eighteenth and nineteenth lenses L18, L19 are arranged in this order such that the eighteenth lens L18 is located closer to the object than the nineteenth lens L19 is and that the nineteenth lens L19 is located closer to the image plane than the eighteenth lens L18 is. The eighteenth lens L18 and the nineteenth lens L19 are bonded together with an adhesive, for example, to form a bonded lens. That is to say, the bonded lens includes the eighteenth lens L18 and the nineteenth lens L19.

The respective sub-lens groups will be described.

The sub-lens group G2a is made up of a fourth lens L4 having positive power and a fifth lens L5 having negative power. The fourth lens L4 and the fifth lens L5 are arranged in this order such that the fourth lens L4 is located closer to the object than the fifth lens L5 is and that the fifth lens L5 is located closer to the image plane than the fourth lens L4 is. The fourth lens L4 and the fifth lens L5 are bonded together with an adhesive, for example, to form a bonded lens. That is to say, the bonded lens includes the fourth lens L4 and the fifth lens L5.

The sub-lens group G2b is made up of: a sixth lens L6 having negative power; a seventh lens L7 having negative power; and an eighth lens L8 having positive power. The sixth, seventh, and eighth lenses L6, L7, L8 are arranged in this order such that the sixth lens L6 is located closer to the object than the seventh lens L7 or the eighth lens L8 is and that the eighth lens L8 is located closer to the image plane than the sixth lens L6 or the seventh lens L7 is. The seventh lens L7 and the eighth lens L8 are bonded together with an adhesive, for example, to form a bonded lens. That is to say, the bonded lens includes the seventh lens L7 and the eighth lens L8.

The respective lenses will be described one by one.

First, the respective lenses that form the first lens group G1 will be described. The first lens L1 is a meniscus lens having a convex surface facing the object. The second lens L2 is a plano-convex lens having a convex surface facing the object. The third lens L3 is a plano-convex lens having a convex surface facing the object.

Next, the respective lenses that form the second lens group G2 will be described. The fourth lens L4 is a biconvex lens. The fifth lens L5 is a biconcave lens. The sixth lens L6 is a biconcave lens. The seventh lens L7 is a biconcave lens. The eighth lens L8 is a meniscus lens having a convex surface facing the object.

Next, the respective lenses that form the third lens group G3 will be described. The ninth lens L9 is a biconvex lens. The tenth lens L10 is a biconvex lens. The eleventh lens L11 is a biconcave lens.

Next, the respective lenses that form the fourth lens group G4 will be described. The twelfth lens L12 is a biconcave lens. The thirteenth lens L13 is a biconvex lens.

Next, the respective lenses that form the fifth lens group G5 will be described. The fourteenth lens L14 is a plano-convex lens having a convex surface facing the image plane. The fifteenth lens L15 is a biconcave lens.

Next, the respective lenses that form the sixth lens group G6 will be described. The sixteenth lens L16 is a biconvex lens. The seventeenth lens L17 is a meniscus lens having a convex surface facing the image plane.

Next, the respective lenses that form the seventh lens group G7 will be described. The eighteenth lens L18 is a biconcave lens. The nineteenth lens L19 is a meniscus lens having a convex surface facing the object.

While the imaging optical system according to the second embodiment is zooming from the wide-angle end toward the telephoto end during a shooting session, the first lens group G1, the third lens group G3, the fourth lens group G4, the fifth lens group G5, and the seventh lens group G7 all move toward the object with respect to the image plane S. In the meantime, as the imaging optical system is zooming from the wide-angle end toward the telephoto end during the shooting session, the first, third, fourth, fifth, and seventh lens groups G1, G3, G4, G5, G7 move along the optical axis such that the interval between the first lens group G1 and the second lens group G2 increases, the interval between the second lens group G2 and the third lens group G3 decreases, the interval between the third lens group G3 and the fourth lens group G4 decreases and then increases, the interval between the fourth lens group G4 and the fifth lens group G5 increases and then decreases, the interval between the fifth lens group G5 and the sixth lens group G6 increases, the interval between the sixth lens group G6 and the seventh lens group G7 decreases, and the interval between the seventh lens group G7 and the image plane S increases.

While the imaging optical system according to the second embodiment is focusing to make a transition from the infinity in-focus state toward the close-object in-focus state, the fifth lens group G5 moves along the optical axis toward the image plane.

When any camera shake or any vibration caused by external force during a shooting session is detected by a gyrosensor provided for at least one of an interchangeable lens unit holding the imaging optical system or an image capture device to which the interchangeable lens unit is attached, the sub-lens group G2b (forming a group of image stabilizer lenses) which belong to the second lens group G2 moves perpendicularly to the optical axis (i.e., in a direction in which the image blur is reduced) to optically compensate for the image blur that may be caused by the camera shake or the vibration due to external force. These image blur compensation lenses allow the imaging optical system to compensate for the shift of the image point due to the vibration of the overall system. That is to say, this allows the imaging optical system to optically compensate for the image blur due to camera shake, vibrations, and other disturbances.

### Third Embodiment

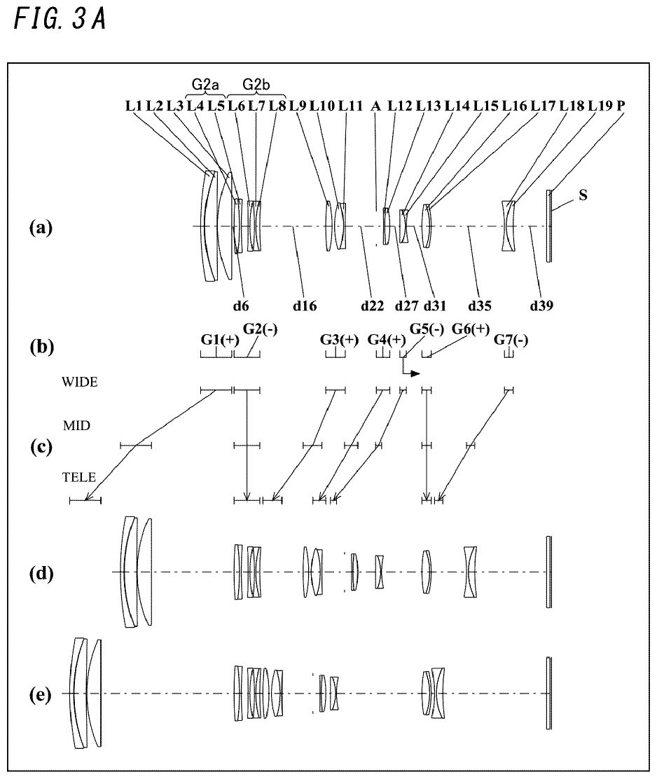

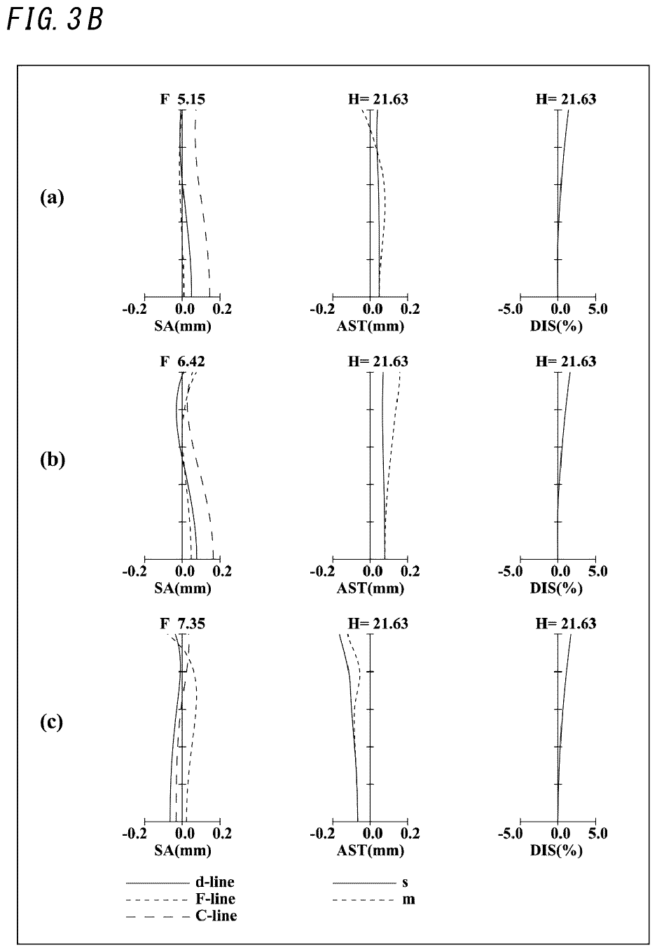

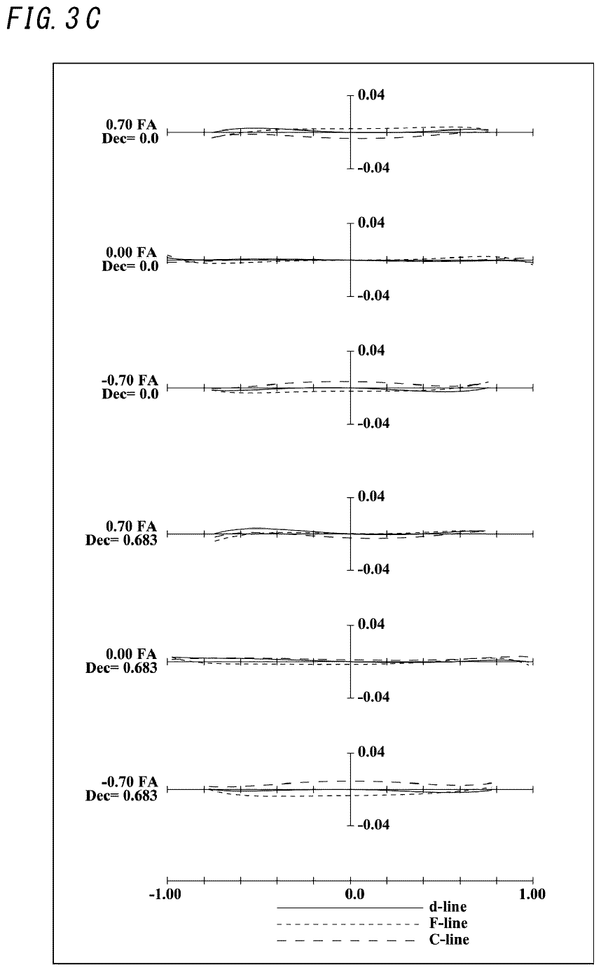

FIG. 3A illustrates an imaging optical system according to a third embodiment.

The imaging optical system includes: a first lens group G1 having positive power; a second lens group G2 having negative power; a third lens group G3 having positive power; a fourth lens group G4 having positive power; a fifth lens group G5 having negative power; a sixth lens group G6 having positive power; and a seventh lens group G7 having negative power. The first, second, third, fourth, fifth, sixth, and seventh lens groups G1, G2, G3, G4, G5, G6, G7 are arranged in this order such that the first lens group G1 is located closer to an object than any of the second, third, fourth, fifth, sixth or seventh lens group G2, G3, G4, G5, G6, G7 is and that the seventh lens group G7 is located closer to an image plane than any of the first, second, third, fourth, fifth, or sixth lens group G1, G2, G3, G4, G5, G6 is.

The imaging optical system forms an image at a point on the image plane S.

The respective lens groups will be described one by one.

The first lens group G1 is made up of: a first lens L1 having negative power; a second lens L2 having positive power; and a third lens L3 having positive power. The first lens L1, the second lens L2, and the third lens L3 are arranged in this order such that the first lens L1 is located closer to the object than any other member of this first lens group G1 is and that the third lens L3 is located closer to the image plane than any other member of this first lens group G1 is.

The second lens group G2 is made up of a sub-lens group G2a having positive power and a sub-lens group G2b having negative power. The sub-lens group G2a and the sub-lens group G2b are arranged in this order such that the sub-lens group G2a is located closer to the object than the sub-lens group G2b is and that the sub-lens group G2b is located closer to the image plane than the sub-lens group G2a is.

The third lens group G3 is made up of: a ninth lens L9 having positive power; a tenth lens L10 having positive power; and an eleventh lens L11 having negative power. The ninth lens L9, the tenth lens L10, and the eleventh lens L11 are arranged in this order such that the ninth lens L9 is located closer to the object than any other member of this third lens group G3 is and that the eleventh lens L11 is located closer to the image plane than any other member of this third lens group G3 is. The tenth lens L10 and the eleventh lens L11 are bonded together with an adhesive, for example, to form a bonded lens. That is to say, the bonded lens includes the tenth lens L10 and the eleventh lens L11.

The fourth lens group G4 is made up of: an aperture stop A; a twelfth lens L12 having negative power; and a thirteenth lens L13 having positive power. The aperture stop A and the twelfth and thirteenth lenses L12, L13 are arranged in this order such that the aperture stop A is located closer to the object than any other member of this fourth lens group G4 is and that the thirteenth lens L13 is located closer to the image plane than any other member of this fourth lens group G4 is. The twelfth lens L12 and the thirteenth lens L13 are bonded together with an adhesive, for example, to form a bonded lens. That is to say, the bonded lens includes the twelfth lens L12 and the thirteenth lens L13.

The fifth lens group G5 is made up of a fourteenth lens L14 having positive power and a fifteenth lens L15 having negative power. The fourteenth and fifteenth lenses L14, L15 are arranged in this order such that the fourteenth lens L14 is located closer to the object than the fifteenth lens L15 is and that the fifteenth lens L15 is located closer to the image plane than the fourteenth lens L14 is. The fourteenth lens L14 and the fifteenth lens L15 are bonded together with an adhesive, for example, to form a bonded lens. That is to say, the bonded lens includes the fourteenth lens L14 and the fifteenth lens L15.

The sixth lens group G6 is made up of a sixteenth lens L16 having positive power and a seventeenth lens L17 having negative power. The sixteenth and seventeenth lenses L16, L17 are arranged in this order such that the sixteenth lens L16 is located closer to the object than the seventeenth lens L17 is and that the seventeenth lens L17 is located closer to the image plane than the sixteenth lens L16 is. The sixteenth lens L16 and the seventeenth lens L17 are bonded together with an adhesive, for example, to form a bonded lens. That is to say, the bonded lens includes the sixteenth lens L16 and the seventeenth lens L17.

The seventh lens group G7 is made up of an eighteenth lens L18 having negative power and a nineteenth lens L19 having positive power. The eighteenth and nineteenth lenses L18, L19 are arranged in this order such that the eighteenth lens L18 is located closer to the object than the nineteenth lens L19 is and that the nineteenth lens L19 is located closer to the image plane than the eighteenth lens L18 is. The eighteenth lens L18 and the nineteenth lens L19 are bonded together with an adhesive, for example, to form a bonded lens. That is to say, the bonded lens includes the eighteenth lens L18 and the nineteenth lens L19.

The respective sub-lens groups will be described.

The sub-lens group G2a is made up of a fourth lens L4 having positive power and a fifth lens L5 having negative power. The fourth lens L4 and the fifth lens L5 are arranged in this order such that the fourth lens L4 is located closer to the object than the fifth lens L5 is and that the fifth lens L5 is located closer to the image plane than the fourth lens L4 is. The fourth lens L4 and the fifth lens L5 are bonded together with an adhesive, for example, to form a bonded lens. That is to say, the bonded lens includes the fourth lens L4 and the fifth lens L5.

The sub-lens group G2b is made up of: a sixth lens L6 having negative power, a seventh lens L7 having negative power, and an eighth lens L8 having positive power. The sixth, seventh, and eighth lenses L6, L7, L8 are arranged in this order such that the sixth lens L6 is located closer to the object than the seventh lens L7 or the eighth lens L8 is and that the eighth lens L8 is located closer to the image plane than the sixth lens L6 or the seventh lens L7 is. The seventh lens L7 and the eighth lens L8 are bonded together with an adhesive, for example, to form a bonded lens. That is to say, the bonded lens includes the seventh lens L7 and the eighth lens L8. The respective lenses will be described one by one.

First, the respective lenses that form the first lens group G1 will be described. The first lens L1 is a meniscus lens having a convex surface facing the object. The second lens L2 is a meniscus lens having a convex surface facing the object. The third lens L3 is a biconvex lens.

Next, the respective lenses that form the second lens group G2 will be described. The fourth lens L4 is a biconvex lens. The fifth lens L5 is a biconcave lens. The sixth lens L6 is a biconcave lens. The seventh lens L7 is a biconcave lens. The eighth lens L8 is a meniscus lens having a convex surface facing the object.

Next, the respective lenses that form the third lens group G3 will be described. The ninth lens L9 is a biconvex lens. The tenth lens L10 is a biconvex lens. The eleventh lens L11 is a biconcave lens.

Next, the respective lenses that form the fourth lens group G4 will be described. The twelfth lens L12 is a biconcave lens. The thirteenth lens L13 is a biconvex lens.

Next, the respective lenses that form the fifth lens group G5 will be described. The fourteenth lens L14 is a meniscus lens having a convex surface facing the image plane. The fifteenth lens L15 is a biconcave lens.

Next, the respective lenses that form the sixth lens group G6 will be described. The sixteenth lens L16 is a biconvex lens. The seventeenth lens L17 is a meniscus lens having a convex surface facing the image plane.

Next, the respective lenses that form the seventh lens group G7 will be described. The eighteenth lens L18 is a biconcave lens. The nineteenth lens L19 is a meniscus lens having a convex surface facing the object.

While the imaging optical system according to the third embodiment is zooming from the wide-angle end toward the telephoto end during a shooting session, the first lens group G1, the third lens group G3, the fourth lens group G4, the fifth lens group G5, and the seventh lens group G7 all move toward the object with respect to the image plane S. In the meantime, as the imaging optical system is zooming from the wide-angle end toward the telephoto end during the shooting session, the first, third, fourth, fifth, and seventh lens groups G1, G3, G4, G5, G7 move along the optical axis such that the interval between the first lens group G1 and the second lens group G2 increases, the interval between the second lens group G2 and the third lens group G3 decreases, the interval between the third lens group G3 and the fourth lens group G4 decreases and then increases, the interval between the fourth lens group G4 and the fifth lens group G5 increases and then decreases, the interval between the fifth lens group G5 and the sixth lens group G6 increases, the interval between the sixth lens group G6 and the seventh lens group G7 decreases, and the interval between the seventh lens group G7 and the image plane S increases.

While the imaging optical system according to the third embodiment is focusing to make a transition from the infinity in-focus state toward the close-object in-focus state, the fifth lens group G5 moves along the optical axis toward the image plane.

When any camera shake or any vibration caused by external force during a shooting session is detected by a gyrosensor provided for at least one of an interchangeable lens unit holding the imaging optical system or an image capture device to which the interchangeable lens unit is attached, the sub-lens group G2b (forming a group of image stabilizer lenses) which belong to the second lens group G2 moves perpendicularly to the optical axis (i.e., in a direction in which the image blur is reduced) to optically compensate for the image blur that may be caused by the camera shake or the vibration due to external force. These image blur compensation lenses allow the imaging optical system to compensate for the shift of the image point due to the vibration of the overall system. That is to say, this allows the imaging optical system to optically compensate for the image blur due to camera shake, vibrations, and other disturbances.

### Fourth Embodiment

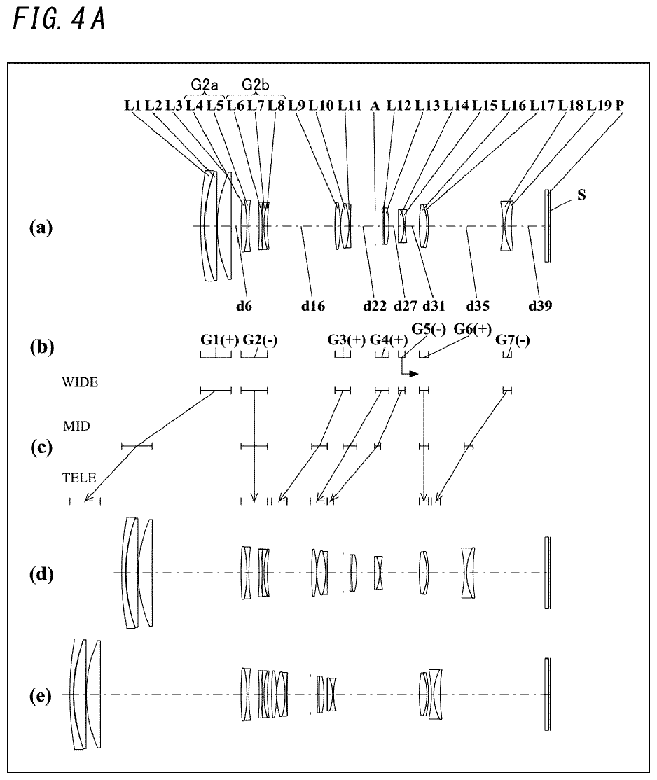

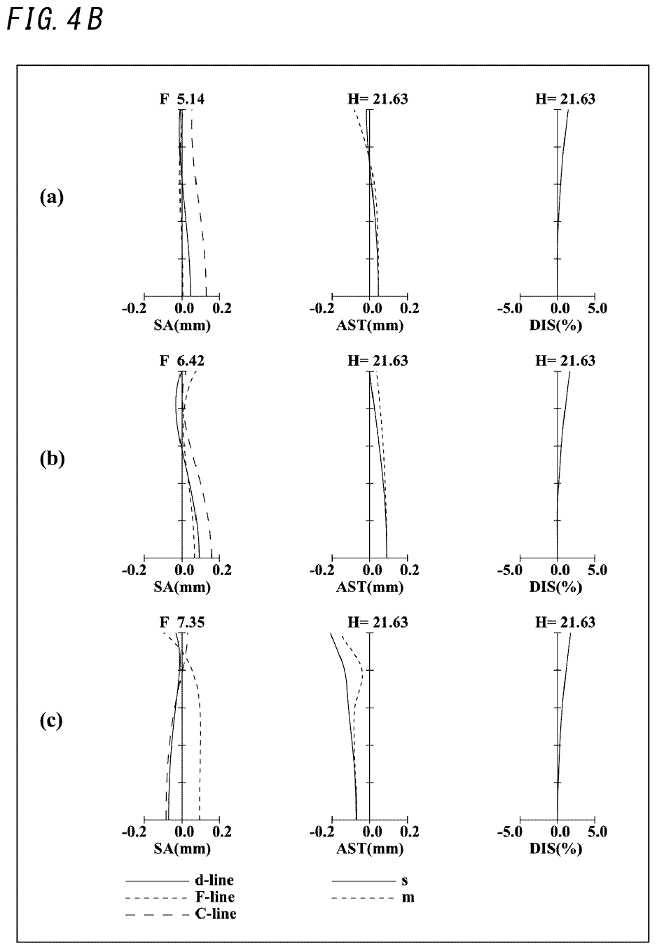

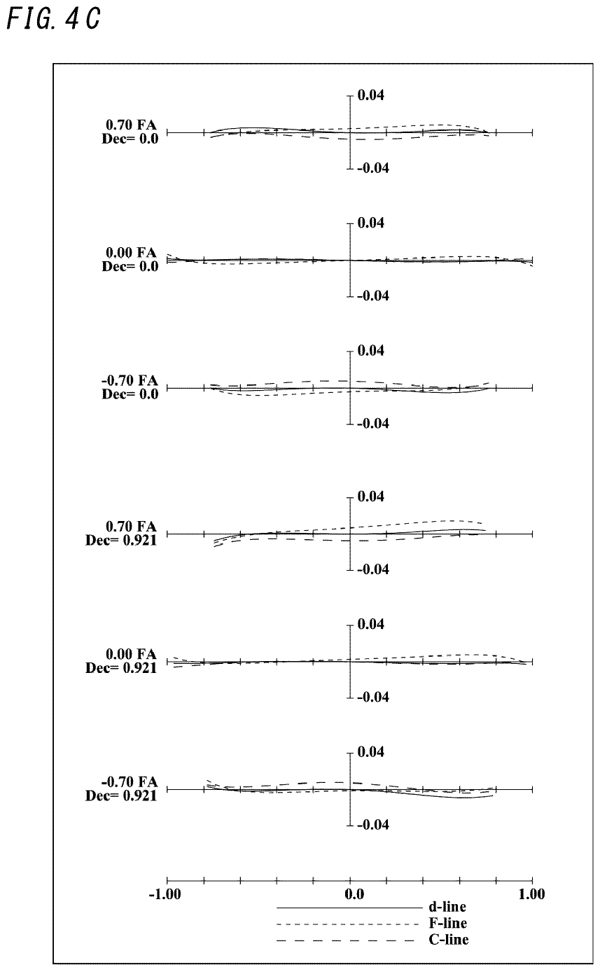

FIG. 4A illustrates an imaging optical system according to a fourth embodiment.

The imaging optical system includes: a first lens group G1 having positive power; a second lens group G2 having negative power; a third lens group G3 having positive power; a fourth lens group G4 having positive power; a fifth lens group G5 having negative power; a sixth lens group G6 having positive power; and a seventh lens group G7 having negative power. The first, second, third, fourth, fifth, sixth, and seventh lens groups G1, G2, G3, G4, G5, G6, G7 are arranged in this order such that the first lens group G1 is located closer to an object than any of the second, third, fourth, fifth, sixth or seventh lens group G2, G3, G4, G5, G6, G7 is and that the seventh lens group G7 is located closer to an image plane than any of the first, second, third, fourth, fifth, or sixth lens group G1, G2, G3, G4, G5, G6 is.

The imaging optical system forms an image at a point on the image plane S.

The respective lens groups will be described one by one.

The first lens group G1 is made up of: a first lens L1 having negative power; a second lens L2 having positive power; and a third lens L3 having positive power. The first lens L1, the second lens L2, and the third lens L3 are arranged in this order such that the first lens L1 is located closer to the object than any other member of this first lens group G1 is and that the third lens L3 is located closer to the image plane than any other member of this first lens group G1 is.

The second lens group G2 is made up of a sub-lens group G2a having negative power and a sub-lens group G2b having negative power. The sub-lens group G2a and the sub-lens group G2b are arranged in this order such that the sub-lens group G2a is located closer to the object than the sub-lens group G2b is and that the sub-lens group G2b is located closer to the image plane than the sub-lens group G2a is.

The third lens group G3 is made up of: a ninth lens L9 having positive power; a tenth lens L10 having positive power; and an eleventh lens L11 having negative power. The ninth lens L9, the tenth lens L10, and the eleventh lens L11 are arranged in this order such that the ninth lens L9 is located closer to the object than any other member of this third lens group G3 is and that the eleventh lens L11 is located closer to the image plane than any other member of this third lens group G3 is. The tenth lens L10 and the eleventh lens L11 are bonded together with an adhesive, for example, to form a bonded lens. That is to say, the bonded lens includes the tenth lens L10 and the eleventh lens L11.

The fourth lens group G4 is made up of: an aperture stop A; a twelfth lens L12 having negative power; and a thirteenth lens L13 having positive power. The aperture stop A and the twelfth and thirteenth lenses L12, L13 are arranged in this order such that the aperture stop A is located closer to the object than any other member of this fourth lens group G4 is and that the thirteenth lens L13 is located closer to the image plane than any other member of this fourth lens group G4 is. The twelfth lens L12 and the thirteenth lens L13 are bonded together with an adhesive, for example, to form a bonded lens. That is to say, the bonded lens includes the twelfth lens L12 and the thirteenth lens L13.

The fifth lens group G5 is made up of a fourteenth lens L14 having positive power and a fifteenth lens L15 having negative power. The fourteenth and fifteenth lenses L14, L15 are arranged in this order such that the fourteenth lens L14 is located closer to the object than the fifteenth lens L15 is and that the fifteenth lens L15 is located closer to the image plane than the fourteenth lens L14 is. The fourteenth lens L14 and the fifteenth lens L15 are bonded together with an adhesive, for example, to form a bonded lens. That is to say, the bonded lens includes the fourteenth lens L14 and the fifteenth lens L15.

The sixth lens group G6 is made up of a sixteenth lens L16 having positive power and a seventeenth lens L17 having negative power. The sixteenth and seventeenth lenses L16, L17 are arranged in this order such that the sixteenth lens L16 is located closer to the object than the seventeenth lens L17 is and that the seventeenth lens L17 is located closer to the image plane than the sixteenth lens L16 is. The sixteenth lens L16 and the seventeenth lens L17 are bonded together with an adhesive, for example, to form a bonded lens. That is to say, the bonded lens includes the sixteenth lens L16 and the seventeenth lens L17.

The seventh lens group G7 is made up of an eighteenth lens L18 having negative power and a nineteenth lens L19 having positive power. The eighteenth and nineteenth lenses L18, L19 are arranged in this order such that the eighteenth lens L18 is located closer to the object than the nineteenth lens L19 is and that the nineteenth lens L19 is located closer to the image plane than the eighteenth lens L18 is. The eighteenth lens L18 and the nineteenth lens L19 are bonded together with an adhesive, for example, to form a bonded lens. That is to say, the bonded lens includes the eighteenth lens L18 and the nineteenth lens L19.

The respective sub-lens groups will be described.

The sub-lens group G2a is made up of a fourth lens L4 having positive power and a fifth lens L5 having negative power. The fourth lens L4 and the fifth lens L5 are arranged in this order such that the fourth lens L4 is located closer to the object than the fifth lens L5 is and that the fifth lens L5 is located closer to the image plane than the fourth lens L4 is. The fourth lens L4 and the fifth lens L5 are bonded together with an adhesive, for example, to form a bonded lens. That is to say, the bonded lens includes the fourth lens L4 and the fifth lens L5.

The sub-lens group G2b is made up of: a sixth lens L6 having negative power; a seventh lens L7 having negative power; and an eighth lens L8 having positive power. The sixth, seventh, and eighth lenses L6, L7, L8 are arranged in this order such that the sixth lens L6 is located closer to the object than the seventh lens L7 or the eighth lens L8 is and that the eighth lens L8 is located closer to the image plane than the sixth lens L6 or the seventh lens L7 is. The seventh lens L7 and the eighth lens L8 are bonded together with an adhesive, for example, to form a bonded lens. That is to say, the bonded lens includes the seventh lens L7 and the eighth lens L8.

The respective lenses will be described one by one.

First, the respective lenses that form the first lens group G1 will be described. The first lens L1 is a meniscus lens having a convex surface facing the object. The second lens L2 is a meniscus lens having a convex surface facing the object. The third lens L3 is a meniscus lens having a convex surface facing the object.

Next, the respective lenses that form the second lens group G2 will be described. The fourth lens L4 is a biconvex lens. The fifth lens L5 is a biconcave lens. The sixth lens L6 is a biconcave lens. The seventh lens L7 is a meniscus lens having a convex surface facing the object. The eighth lens L8 is a meniscus lens having a convex surface facing the object.

Next, the respective lenses that form the third lens group G3 will be described. The ninth lens L9 is a biconvex lens. The tenth lens L10 is a biconvex lens. The eleventh lens L11 is a biconcave lens.

Next, the respective lenses that form the fourth lens group G4 will be described. The twelfth lens L12 is a biconcave lens. The thirteenth lens L13 is a biconvex lens. Next, the respective lenses that form the fifth lens group G5 will be described. The fourteenth lens L14 is a meniscus lens having a convex surface facing the image plane. The fifteenth lens L15 is a biconcave lens.

Next, the respective lenses that form the sixth lens group G6 will be described. The sixteenth lens L16 is a biconvex lens. The seventeenth lens L17 is a meniscus lens having a convex surface facing the image plane.

Next, the respective lenses that form the seventh lens group G7 will be described. The eighteenth lens L18 is a biconcave lens. The nineteenth lens L19 is a meniscus lens having a convex surface facing the object.

While the imaging optical system according to the fourth embodiment is zooming from the wide-angle end toward the telephoto end during a shooting session, the first lens group G1, the third lens group G3, the fourth lens group G4, the fifth lens group G5, and the seventh lens group G7 all move toward the object with respect to the image plane S. In the meantime, as the imaging optical system is zooming from the wide-angle end toward the telephoto end during the shooting session, the first, third, fourth, fifth, and seventh lens groups G1, G3, G4, G5, G7 move along the optical axis such that the interval between the first lens group G1 and the second lens group G2 increases, the interval between the second lens group G2 and the third lens group G3 decreases, the interval between the third lens group G3 and the fourth lens group G4 decreases and then increases, the interval between the fourth lens group G4 and the fifth lens group G5 increases and then decreases, the interval between the fifth lens group G5 and the sixth lens group G6 increases, the interval between the sixth lens group G6 and the seventh lens group G7 decreases, and the interval between the seventh lens group G7 and the image plane S increases.

While the imaging optical system according to the fourth embodiment is focusing to make a transition from the infinity in-focus state toward the close-object in-focus state, the fifth lens group G5 moves along the optical axis toward the image plane.

When any camera shake or any vibration caused by external force during a shooting session is detected by a gyrosensor provided for at least one of an interchangeable lens unit holding the imaging optical system or an image capture device to which the interchangeable lens unit is attached, the sub-lens group G2b (forming a group of image stabilizer lenses) which belong to the second lens group G2 moves perpendicularly to the optical axis (i.e., in a direction in which the image blur is reduced) to optically compensate for the image blur that may be caused by the camera shake or the vibration due to external force. These image blur compensation lenses allow the imaging optical system to compensate for the shift of the image point due to the vibration of the overall system. That is to say, this allows the imaging optical system to optically compensate for the image blur due to camera shake, vibrations, and other disturbances.

### Fifth Embodiment

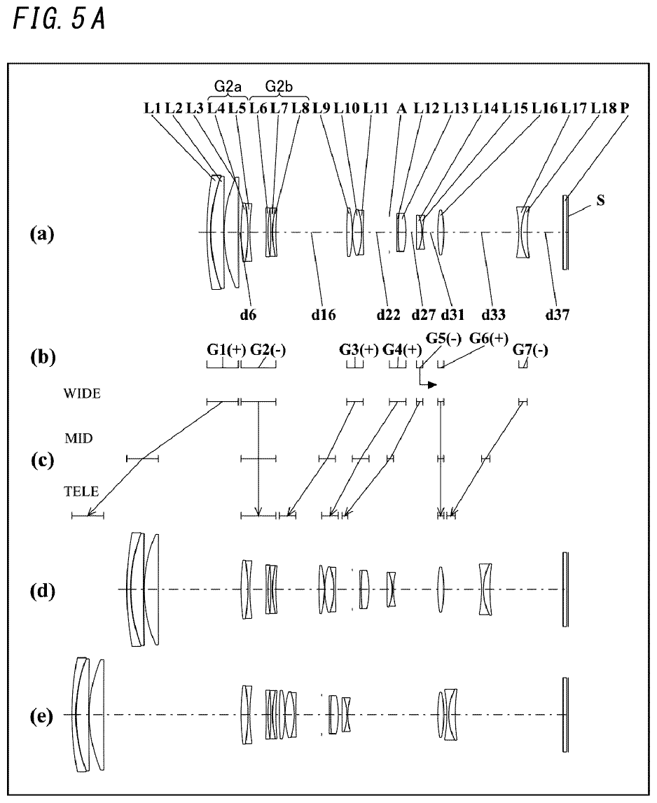

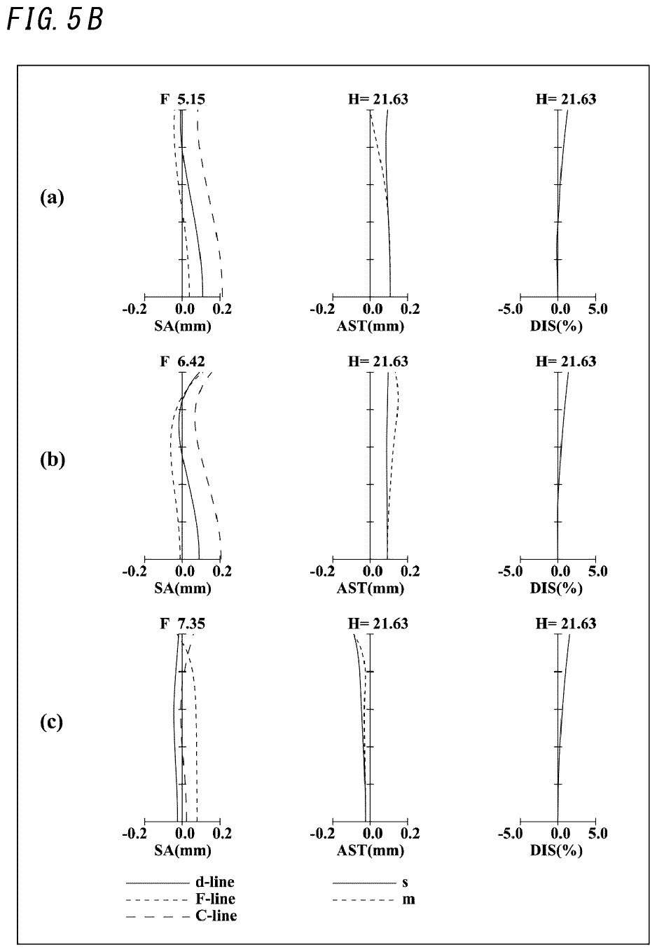

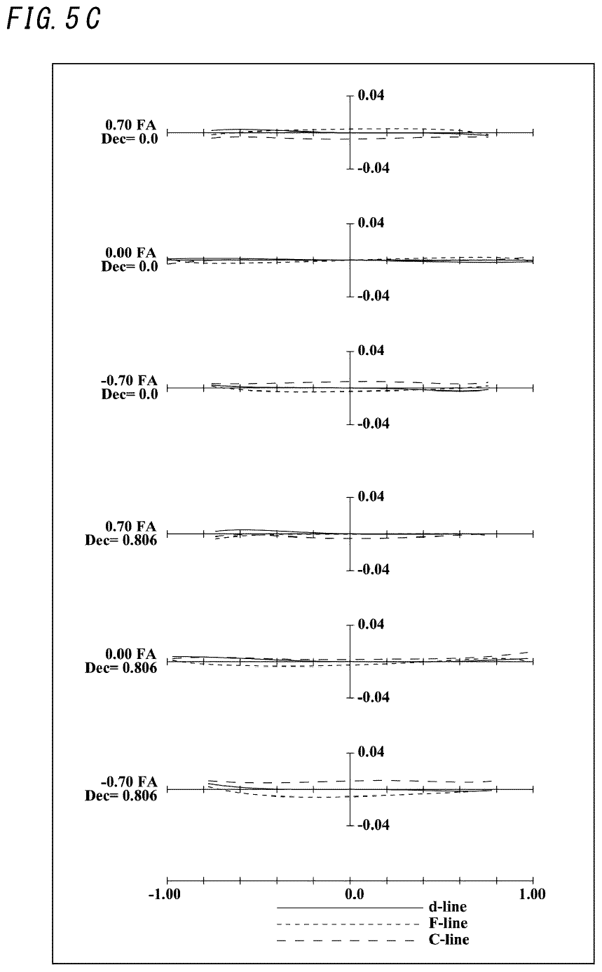

FIG. 5A illustrates an imaging optical system according to a fifth embodiment.

The imaging optical system includes: a first lens group G1 having positive power; a second lens group G2 having negative power; a third lens group G3 having positive power; a fourth lens group G4 having positive power; a fifth lens group G5 having negative power; a sixth lens group G6 having positive power; and a seventh lens group G7 having negative power. The first, second, third, fourth, fifth, sixth, and seventh lens groups G1, G2, G3, G4, G5, G6, G7 are arranged in this order such that the first lens group G1 is located closer to an object than any of the second, third, fourth, fifth, sixth or seventh lens group G2, G3, G4, G5, G6, G7 is and that the seventh lens group G7 is located closer to an image plane than any of the first, second, third, fourth, fifth, or sixth lens group G1, G2, G3, G4, G5, G6 is.

The imaging optical system forms an image at a point on the image plane S.

The respective lens groups will be described one by one.

The first lens group G1 is made up of: a first lens L1 having negative power; a second lens L2 having positive power; and a third lens L3 having positive power. The first lens L1, the second lens L2, and the third lens L3 are arranged in this order such that the first lens L1 is located closer to the object than any other member of this first lens group G1 is and that the third lens L3 is located closer to the image plane than any other member of this first lens group G1 is.

The second lens group G2 is made up of a sub-lens group G2a having negative power and a sub-lens group G2b having negative power. The sub-lens group G2a and the sub-lens group G2b are arranged in this order such that the sub-lens group G2a is located closer to the object than the sub-lens group G2b is and that the sub-lens group G2b is located closer to the image plane than the sub-lens group G2a is.

The third lens group G3 is made up of: a ninth lens L9 having positive power; a tenth lens L10 having positive power; and an eleventh lens L11 having negative power. The ninth lens L9, the tenth lens L10, and the eleventh lens L11 are arranged in this order such that the ninth lens L9 is located closer to the object than any other member of this third lens group G3 is and that the eleventh lens L11 is located closer to the image plane than any other member of this third lens group G3 is. The tenth lens L10 and the eleventh lens L11 are bonded together with an adhesive, for example, to form a bonded lens. That is to say, the bonded lens includes the tenth lens L10 and the eleventh lens L11.

The fourth lens group G4 is made up of: an aperture stop A; a twelfth lens L12 having negative power; and a thirteenth lens L13 having positive power. The aperture stop A and the twelfth and thirteenth lenses L12, L13 are arranged in this order such that the aperture stop A is located closer to the object than any other member of this fourth lens group G4 is and that the thirteenth lens L13 is located closer to the image plane than any other member of this fourth lens group G4 is. The twelfth lens L12 and the thirteenth lens L13 are bonded together with an adhesive, for example, to form a bonded lens. That is to say, the bonded lens includes the twelfth lens L12 and the thirteenth lens L13.

The fifth lens group G5 is made up of a fourteenth lens L14 having positive power and a fifteenth lens L15 having negative power. The fourteenth and fifteenth lenses L14, L15 are arranged in this order such that the fourteenth lens L14 is located closer to the object than the fifteenth lens L15 is and that the fifteenth lens L15 is located closer to the image plane than the fourteenth lens L14 is. The fourteenth lens L14 and the fifteenth lens L15 are bonded together with an adhesive, for example, to form a bonded lens. That is to say, the bonded lens includes the fourteenth lens L14 and the fifteenth lens L15.

The sixth lens group G6 consists of a sixteenth lens L16 having positive power.

The seventh lens group G7 is made up of a seventeenth lens L17 having negative power and an eighteenth lens L18 having positive power. The seventeenth and eighteenth lenses L17, L18 are arranged in this order such that the seventeenth lens L17 is located closer to the object than the eighteenth lens L18 is and that the eighteenth lens L18 is located closer to the image plane than the seventeenth lens L17 is. The seventeenth lens L17 and the eighteenth lens L18 are bonded together with an adhesive, for example, to form a bonded lens. That is to say, the bonded lens includes the seventeenth lens L17 and the eighteenth lens L18.

The respective sub-lens groups will be described.

The sub-lens group G2a is made up of a fourth lens L4 having positive power and a fifth lens L5 having negative power. The fourth lens L4 and the fifth lens L5 are arranged in this order such that the fourth lens L4 is located closer to the object than the fifth lens L5 is and that the fifth lens L5 is located closer to the image plane than the fourth lens L4 is. The fourth lens L4 and the fifth lens L5 are bonded together with an adhesive, for example, to form a bonded lens. That is to say, the bonded lens includes the fourth lens L4 and the fifth lens L5.

The sub-lens group G2b is made up of: a sixth lens L6 having negative power; a seventh lens L7 having negative power; and an eighth lens L8 having positive power. The sixth, seventh, and eighth lenses L6, L7, L8 are arranged in this order such that the sixth lens L6 is located closer to the object than the seventh lens L7 or the eighth lens L8 is and that the eighth lens L8 is located closer to the image plane than the sixth lens L6 or the seventh lens L7 is. The seventh lens L7 and the eighth lens L8 are bonded together with an adhesive, for example, to form a bonded lens. That is to say, the bonded lens includes the seventh lens L7 and the eighth lens L8.

The respective lenses will be described one by one.

First, the respective lenses that form the first lens group G1 will be described. The first lens L1 is a meniscus lens having a convex surface facing the object. The second lens L2 is a meniscus lens having a convex surface facing the object. The third lens L3 is a meniscus lens having a convex surface facing the object.

Next, the respective lenses that form the second lens group G2 will be described. The fourth lens L4 is a biconvex lens. The fifth lens L5 is a biconcave lens. The sixth lens L6 is a biconcave lens. The seventh lens L7 is a biconcave lens. The eighth lens L8 is a meniscus lens having a convex surface facing the object.

Next, the respective lenses that form the third lens group G3 will be described. The ninth lens L9 is a biconvex lens. The tenth lens L10 is a biconvex lens. The eleventh lens L11 is a biconcave lens.

Next, the respective lenses that form the fourth lens group G4 will be described. The twelfth lens L12 is a biconcave lens. The thirteenth lens L13 is a biconvex lens.

Next, the respective lenses that form the fifth lens group G5 will be described. The fourteenth lens L14 is a biconvex lens. The fifteenth lens L15 is a biconcave lens.

Next, the lens serving as the sixth lens group G6 will be described. The sixteenth lens L16 is a biconvex lens.

Next, the respective lenses that form the seventh lens group G7 will be described. The seventeenth lens L17 is a biconcave lens. The eighteenth lens L18 is a meniscus lens having a convex surface facing the object.

While the imaging optical system according to the fifth embodiment is zooming from the wide-angle end toward the telephoto end during a shooting session, the first lens group G1, the third lens group G3, the fourth lens group G4, the fifth lens group G5, and the seventh lens group G7 all move toward the object with respect to the image plane S. In the meantime, as the imaging optical system is zooming from the wide-angle end toward the telephoto end during the shooting session, the first, third, fourth, fifth, and seventh lens groups G1, G3, G4, G5, G7 move along the optical axis such that the interval between the first lens group G1 and the second lens group G2 increases, the interval between the second lens group G2 and the third lens group G3 decreases, the interval between the third lens group G3 and the fourth lens group G4 decreases and then increases, the interval between the fourth lens group G4 and the fifth lens group G5 increases and then decreases, the interval between the fifth lens group G5 and the sixth lens group G6 increases, the interval between the sixth lens group G6 and the seventh lens group G7 decreases, and the interval between the seventh lens group G7 and the image plane S increases.

While the imaging optical system according to the fifth embodiment is focusing to make a transition from the infinity in-focus state toward the close-object in-focus state, the fifth lens group G5 moves along the optical axis toward the image plane.

When any camera shake or any vibration caused by external force during a shooting session is detected by a gyrosensor provided for at least one of an interchangeable lens unit holding the imaging optical system or an image capture device to which the interchangeable lens unit is attached, the sub-lens group G2b (forming a group of image stabilizer lenses) which belong to the second lens group G2 moves perpendicularly to the optical axis (i.e., in a direction in which the image blur is reduced) to optically compensate for the image blur that may be caused by the camera shake or the vibration due to external force. These image blur compensation lenses allow the imaging optical system to compensate for the shift of the image point due to the vibration of the overall system. That is to say, this allows the imaging optical system to optically compensate for the image blur due to camera shake, vibrations, and other disturbances.

### Sixth Embodiment

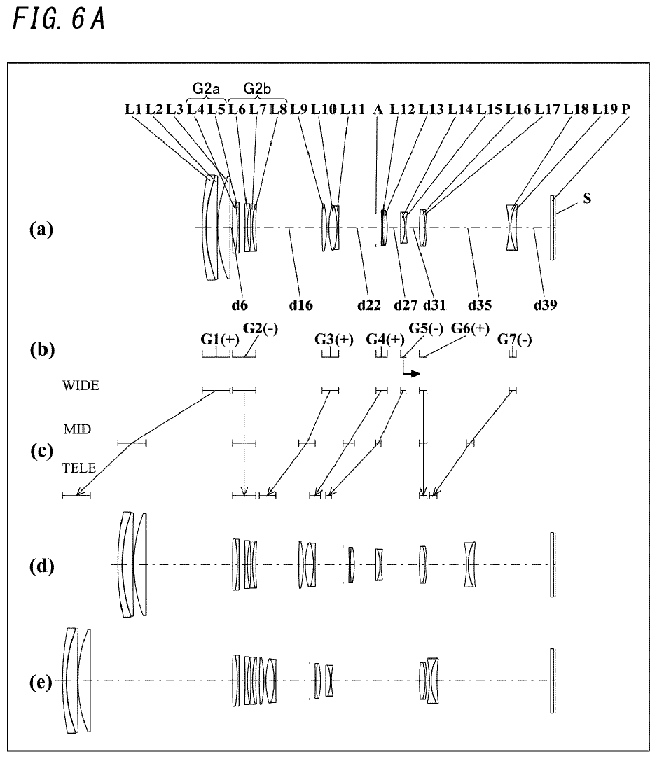

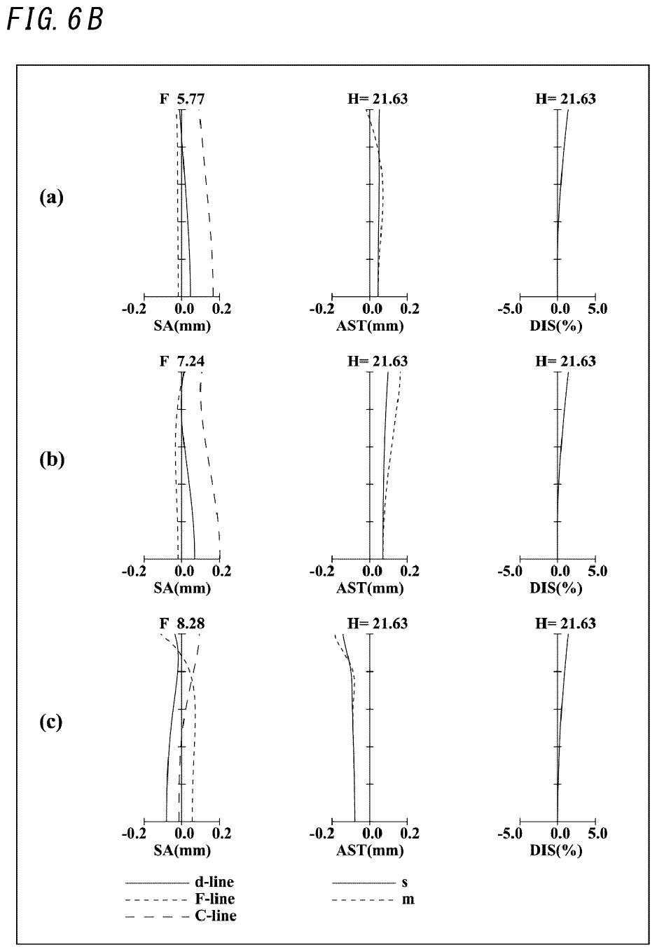

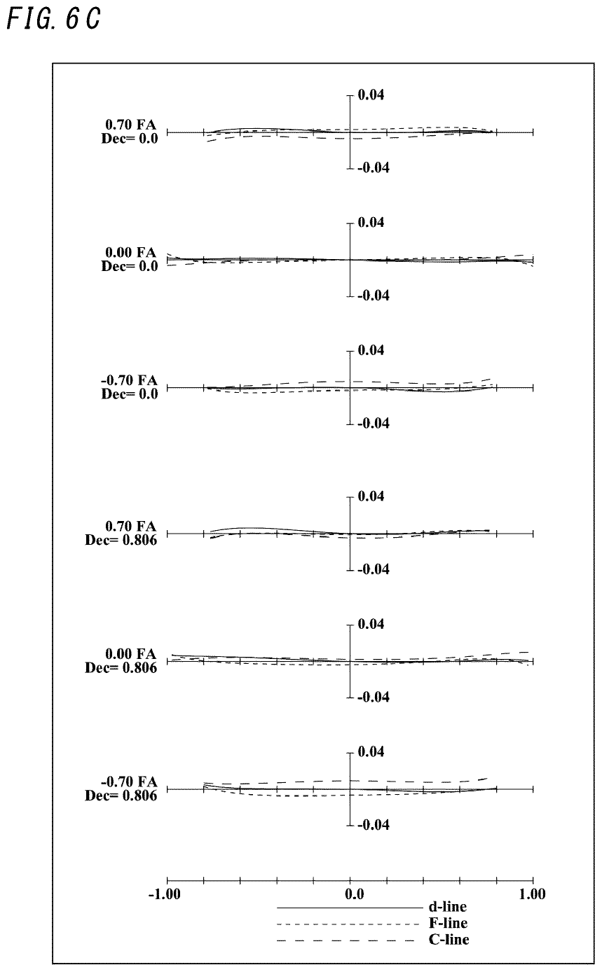

FIG. 6A illustrates an imaging optical system according to a sixth embodiment.

The imaging optical system includes: a first lens group G1 having positive power; a second lens group G2 having negative power; a third lens group G3 having positive power; a fourth lens group G4 having positive power; a fifth lens group G5 having negative power; a sixth lens group G6 having positive power; and a seventh lens group G7 having negative power. The first, second, third, fourth, fifth, sixth, and seventh lens groups G1, G2, G3, G4, G5, G6, G7 are arranged in this order such that the first lens group G1 is located closer to an object than any of the second, third, fourth, fifth, sixth or seventh lens group G2, G3, G4, G5, G6, G7 is and that the seventh lens group G7 is located closer to an image plane than any of the first, second, third, fourth, fifth, or sixth lens group G1, G2, G3, G4, G5, G6 is.

The imaging optical system forms an image at a point on the image plane S.

The respective lens groups will be described one by one.

The first lens group G1 is made up of: a first lens L1 having negative power; a second lens L2 having positive power; and a third lens L3 having positive power. The first lens L1, the second lens L2, and the third lens L3 are arranged in this order such that the first lens L1 is located closer to the object than any other member of this first lens group G1 is and that the third lens L3 is located closer to the image plane than any other member of this first lens group G1 is.

The second lens group G2 is made up of a sub-lens group G2a having positive power and a sub-lens group G2b having negative power. The sub-lens group G2a and the sub-lens group G2b are arranged in this order such that the sub-lens group G2a is located closer to the object than the sub-lens group G2b is and that the sub-lens group G2b is located closer to the image plane than the sub-lens group G2a is.

The third lens group G3 is made up of: a ninth lens L9 having positive power; a tenth lens L10 having positive power; and an eleventh lens L11 having negative power. The ninth lens L9, the tenth lens L10, and the eleventh lens L11 are arranged in this order such that the ninth lens L9 is located closer to the object than any other member of this third lens group G3 is and that the eleventh lens L11 is located closer to the image plane than any other member of this third lens group G3 is. The tenth lens L10 and the eleventh lens L11 are bonded together with an adhesive, for example, to form a bonded lens. That is to say, the bonded lens includes the tenth lens L10 and the eleventh lens L11.

The fourth lens group G4 is made up of: an aperture stop A; a twelfth lens L12 having negative power; and a thirteenth lens L13 having positive power. The aperture stop A and the twelfth and thirteenth lenses L12, L13 are arranged in this order such that the aperture stop A is located closer to the object than any other member of this fourth lens group G4 is and that the thirteenth lens L13 is located closer to the image plane than any other member of this fourth lens group G4 is. The twelfth lens L12 and the thirteenth lens L13 are bonded together with an adhesive, for example, to form a bonded lens. That is to say, the bonded lens includes the twelfth lens L12 and the thirteenth lens L13.

The fifth lens group G5 is made up of a fourteenth lens L14 having positive power and a fifteenth lens L15 having negative power. The fourteenth and fifteenth lenses L14, L15 are arranged in this order such that the fourteenth lens L14 is located closer to the object than the fifteenth lens L15 is and that the fifteenth lens L15 is located closer to the image plane than the fourteenth lens L14 is. The fourteenth lens L14 and the fifteenth lens L15 are bonded together with an adhesive, for example, to form a bonded lens. That is to say, the bonded lens includes the fourteenth lens L14 and the fifteenth lens L15.

The sixth lens group G6 is made up of a sixteenth lens L16 having positive power and a seventeenth lens L17 having negative power. The sixteenth and seventeenth lenses L16, L17 are arranged in this order such that the sixteenth lens L16 is located closer to the object than the seventeenth lens L17 is and that the seventeenth lens L17 is located closer to the image plane than the sixteenth lens L16 is. The sixteenth lens L16 and the seventeenth lens L17 are bonded together with an adhesive, for example, to form a bonded lens. That is to say, the bonded lens includes the sixteenth lens L16 and the seventeenth lens L17.

The seventh lens group G7 is made up of an eighteenth lens L18 having negative power and a nineteenth lens L19 having positive power. The eighteenth and nineteenth lenses L18, L19 are arranged in this order such that the eighteenth lens L18 is located closer to the object than the nineteenth lens L19 is and that the nineteenth lens L19 is located closer to the image plane than the eighteenth lens L18 is. The eighteenth lens L18 and the nineteenth lens L19 are bonded together with an adhesive, for example, to form a bonded lens. That is to say, the bonded lens includes the eighteenth lens L18 and the nineteenth lens L19.

The respective sub-lens groups will be described.

The sub-lens group G2a is made up of a fourth lens L4 having positive power and a fifth lens L5 having negative power. The fourth lens L4 and the fifth lens L5 are arranged in this order such that the fourth lens L4 is located closer to the object than the fifth lens L5 is and that the fifth lens L5 is located closer to the image plane than the fourth lens L4 is. The fourth lens L4 and the fifth lens L5 are bonded together with an adhesive, for example, to form a bonded lens. That is to say, the bonded lens includes the fourth lens L4 and the fifth lens L5.

The sub-lens group G2b is made up of: a sixth lens L6 having negative power; a seventh lens L7 having negative power; and an eighth lens L8 having positive power. The sixth, seventh, and eighth lenses L6, L7, L8 are arranged in this order such that the sixth lens L6 is located closer to the object than the seventh lens L7 or the eighth lens L8 is and that the eighth lens L8 is located closer to the image plane than the sixth lens L6 or the seventh lens L7 is. The seventh lens L7 and the eighth lens L8 are bonded together with an adhesive, for example, to form a bonded lens. That is to say, the bonded lens includes the seventh lens L7 and the eighth lens L8.

The respective lenses will be described one by one.

First, the respective lenses that form the first lens group G1 will be described. The first lens L1 is a meniscus lens having a convex surface facing the object. The second lens L2 is a meniscus lens having a convex surface facing the object. The third lens L3 is a biconvex lens.

Next, the respective lenses that form the second lens group G2 will be described. The fourth lens L4 is a biconvex lens. The fifth lens L5 is a meniscus lens having a convex surface facing the image plane. The sixth lens L6 is a biconcave lens. The seventh lens L7 is a biconcave lens. The eighth lens L8 is a meniscus lens having a convex surface facing the object.

Next, the respective lenses that form the third lens group G3 will be described. The ninth lens L9 is a biconvex lens. The tenth lens L10 is a biconvex lens. The eleventh lens L11 is a biconcave lens.

Next, the respective lenses that form the fourth lens group G4 will be described. The twelfth lens L12 is a biconcave lens. The thirteenth lens L13 is a biconvex lens.

Next, the respective lenses that form the fifth lens group G5 will be described. The fourteenth lens L14 is a meniscus lens having a convex surface facing the image plane. The fifteenth lens L15 is a biconcave lens.

Next, the respective lenses that form the sixth lens group G6 will be described. The sixteenth lens L16 is a biconvex lens. The seventeenth lens L17 is a meniscus lens having a convex surface facing the image plane.

Next, the respective lenses that form the seventh lens group G7 will be described. The eighteenth lens L18 is a biconcave lens. The nineteenth lens L19 is a meniscus lens having a convex surface facing the object.

While the imaging optical system according to the sixth embodiment is zooming from the wide-angle end toward the telephoto end during a shooting session, the first lens group G1, the third lens group G3, the fourth lens group G4, the fifth lens group G5, and the seventh lens group G7 all move toward the object with respect to the image plane S. In the meantime, as the imaging optical system is zooming from the wide-angle end toward the telephoto end during the shooting session, the first, second, third, fourth, fifth, sixth, and seventh lens groups G1, G2, G3, G4, G5, G6, G7 move along the optical axis such that the interval between the first lens group G1 and the second lens group G2 increases, the interval between the second lens group G2 and the third lens group G3 decreases, the interval between the third lens group G3 and the fourth lens group G4 decreases and then increases, the interval between the fourth lens group G4 and the fifth lens group G5 increases and then decreases, the interval between the fifth lens group G5 and the sixth lens group G6 increases, the interval between the sixth lens group G6 and the seventh lens group G7 decreases, and the interval between the seventh lens group G7 and the image plane S increases.

While the imaging optical system according to the sixth embodiment is focusing to make a transition from the infinity in-focus state toward the close-object in-focus state, the fifth lens group G5 moves along the optical axis toward the image plane.

When any camera shake or any vibration caused by external force during a shooting session is detected by a gyrosensor provided for at least one of an interchangeable lens unit holding the imaging optical system or an image capture device to which the interchangeable lens unit is attached, the sub-lens group G2b (forming a group of image stabilizer lenses) which belong to the second lens group G2 moves perpendicularly to the optical axis (i.e., in a direction in which the image blur is reduced) to optically compensate for the image blur that may be caused by the camera shake or the vibration due to external force. These image blur compensation lenses allow the imaging optical system to compensate for the shift of the image point due to the vibration of the overall system. That is to say, this allows the imaging optical system to optically compensate for the image blur due to camera shake, vibrations, and other disturbances.

### Seventh Embodiment

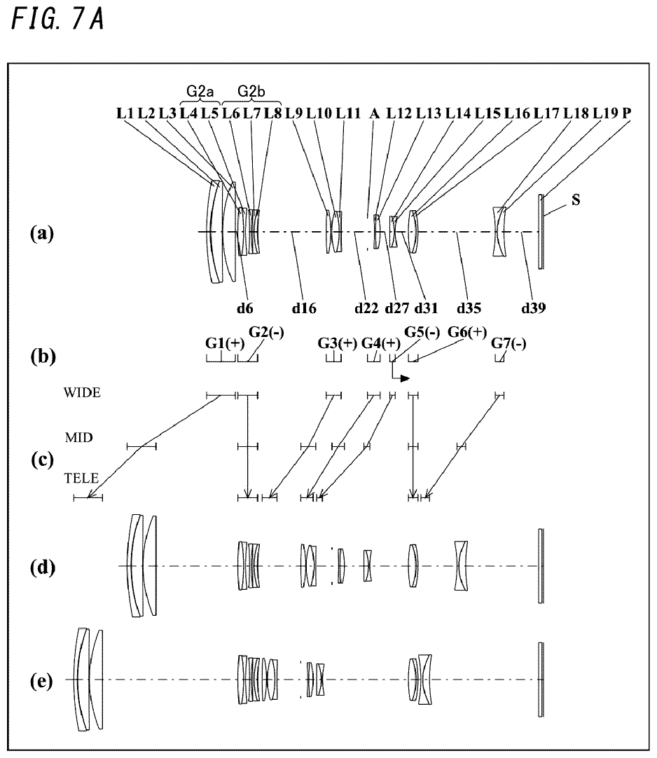

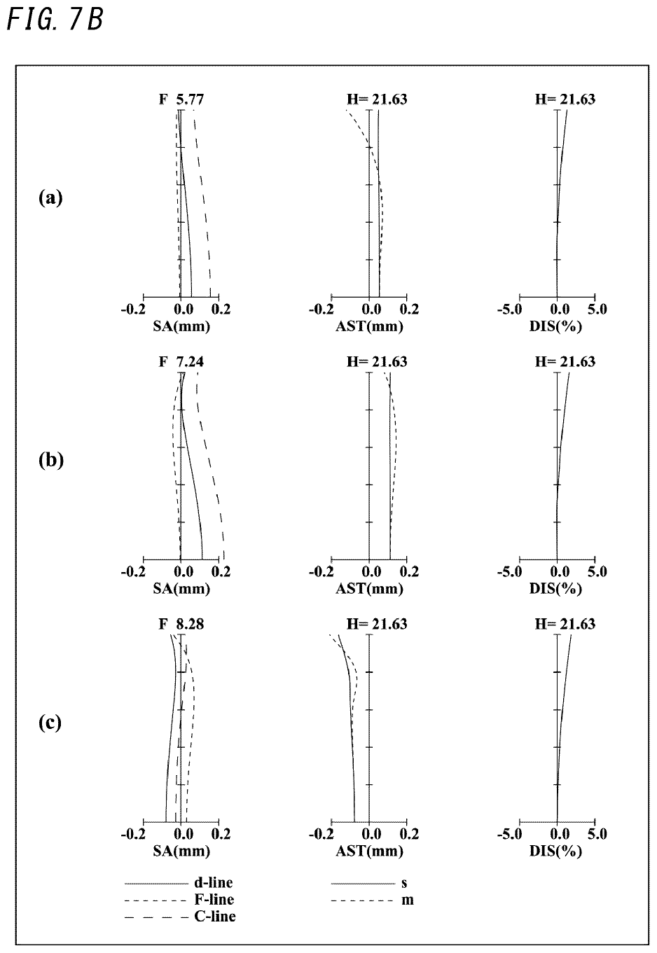

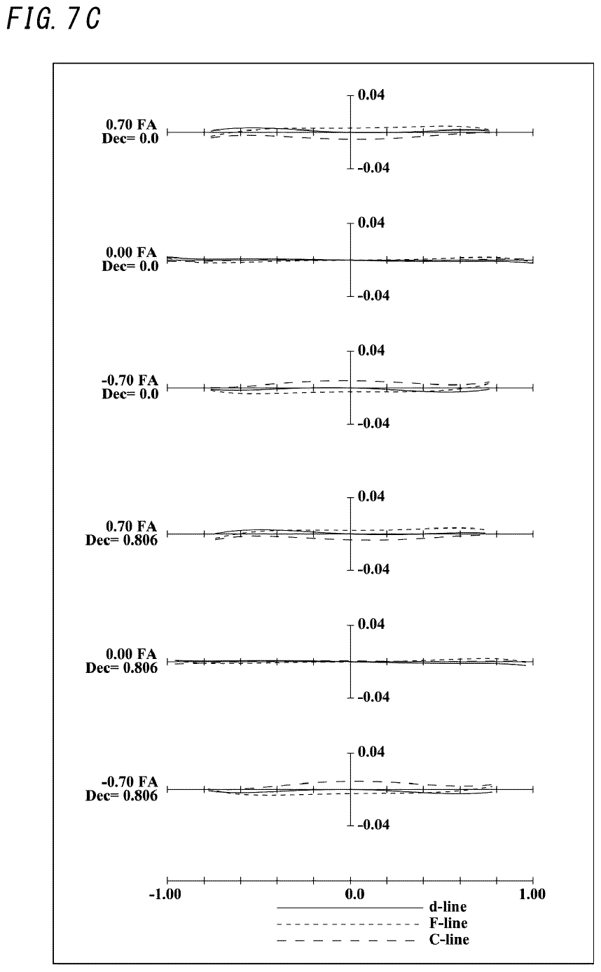

FIG. 7A illustrates an imaging optical system according to a seventh embodiment.

The imaging optical system includes: a first lens group G1 having positive power; a second lens group G2 having negative power; a third lens group G3 having positive power; a fourth lens group G4 having positive power; a fifth lens group G5 having negative power; a sixth lens group G6 having positive power; and a seventh lens group G7 having negative power. The first, second, third, fourth, fifth, sixth, and seventh lens groups G1, G2, G3, G4, G5, G6, G7 are arranged in this order such that the first lens group G1 is located closer to an object than any of the second, third, fourth, fifth, sixth or seventh lens group G2, G3, G4, G5, G6, G7 is and that the seventh lens group G7 is located closer to an image plane than any of the first, second, third, fourth, fifth, or sixth lens group G1, G2, G3, G4, G5, G6 is.

The imaging optical system forms an image at a point on the image plane S.

The respective lens groups will be described one by one.

The first lens group G1 is made up of: a first lens L1 having negative power; a second lens L2 having positive power; and a third lens L3 having positive power. The first lens L1, the second lens L2, and the third lens L3 are arranged in this order such that the first lens L1 is located closer to the object than any other member of this first lens group G1 is and that the third lens L3 is located closer to the image plane than any other member of this first lens group G1 is.

The second lens group G2 is made up of a sub-lens group G2a having negative power and a sub-lens group G2b having negative power. The sub-lens group G2a and the sub-lens group G2b are arranged in this order such that the sub-lens group G2a is located closer to the object than the sub-lens group G2b is and that the sub-lens group G2b is located closer to the image plane than the sub-lens group G2a is.

The third lens group G3 is made up of: a ninth lens L9 having positive power; a tenth lens L10 having positive power; and an eleventh lens L11 having negative power. The ninth lens L9, the tenth lens L10, and the eleventh lens L11 are arranged in this order such that the ninth lens L9 is located closer to the object than any other member of this third lens group G3 is and that the eleventh lens L11 is located closer to the image plane than any other member of this third lens group G3 is. The tenth lens L10 and the eleventh lens L11 are bonded together with an adhesive, for example, to form a bonded lens. That is to say, the bonded lens includes the tenth lens L10 and the eleventh lens L11.

The fourth lens group G4 is made up of: an aperture stop A; a twelfth lens L12 having negative power; and a thirteenth lens L13 having positive power. The aperture stop A and the twelfth and thirteenth lenses L12, L13 are arranged in this order such that the aperture stop A is located closer to the object than any other member of this fourth lens group G4 is and that the thirteenth lens L13 is located closer to the image plane than any other member of this fourth lens group G4 is. The twelfth lens L12 and the thirteenth lens L13 are bonded together with an adhesive, for example, to form a bonded lens. That is to say, the bonded lens includes the twelfth lens L12 and the thirteenth lens L13.

The fifth lens group G5 is made up of a fourteenth lens L14 having positive power and a fifteenth lens L15 having negative power. The fourteenth and fifteenth lenses L14, L15 are arranged in this order such that the fourteenth lens L14 is located closer to the object than the fifteenth lens L15 is and that the fifteenth lens L15 is located closer to the image plane than the fourteenth lens L14 is. The fourteenth lens L14 and the fifteenth lens L15 are bonded together with an adhesive, for example, to form a bonded lens. That is to say, the bonded lens includes the fourteenth lens L14 and the fifteenth lens L15.

The sixth lens group G6 is made up of a sixteenth lens L16 having positive power and a seventeenth lens L17 having negative power. The sixteenth and seventeenth lenses L16, L17 are arranged in this order such that the sixteenth lens L16 is located closer to the object than the seventeenth lens L17 is and that the seventeenth lens L17 is located closer to the image plane than the sixteenth lens L16 is. The sixteenth lens L16 and the seventeenth lens L17 are bonded together with an adhesive, for example, to form a bonded lens. That is to say, the bonded lens includes the sixteenth lens L16 and the seventeenth lens L17.

The seventh lens group G7 is made up of an eighteenth lens L18 having negative power and a nineteenth lens L19 having positive power. The eighteenth and nineteenth lenses L18, L19 are arranged in this order such that the eighteenth lens L18 is located closer to the object than the nineteenth lens L19 is and that the nineteenth lens L19 is located closer to the image plane than the eighteenth lens L18 is. The eighteenth lens L18 and the nineteenth lens L19 are bonded together with an adhesive, for example, to form a bonded lens. That is to say, the bonded lens includes the eighteenth lens L18 and the nineteenth lens L19.

The respective sub-lens groups will be described.

The sub-lens group G2a is made up of a fourth lens L4 having positive power and a fifth lens L5 having negative power. The fourth lens L4 and the fifth lens L5 are arranged in this order such that the fourth lens L4 is located closer to the object than the fifth lens L5 is and that the fifth lens L5 is located closer to the image plane than the fourth lens L4 is. The fourth lens L4 and the fifth lens L5 are bonded together with an adhesive, for example, to form a bonded lens. That is to say, the bonded lens includes the fourth lens L4 and the fifth lens L5.

The sub-lens group G2b is made up of: a sixth lens L6 having negative power, a seventh lens L7 having negative power, and an eighth lens L8 having positive power. The sixth, seventh, and eighth lenses L6, L7, L8 are arranged in this order such that the sixth lens L6 is located closer to the object than the seventh lens L7 or the eighth lens L8 is and that the eighth lens L8 is located closer to the image plane than the sixth lens L6 or the seventh lens L7 is. The seventh lens L7 and the eighth lens L8 are bonded together with an adhesive, for example, to form a bonded lens. That is to say, the bonded lens includes the seventh lens L7 and the eighth lens L8. The respective lenses will be described one by one.

First, the respective lenses that form the first lens group G1 will be described. The first lens L1 is a meniscus lens having a convex surface facing the object. The second lens L2 is a meniscus lens having a convex surface facing the object. The third lens L3 is a biconvex lens.

Next, the respective lenses that form the second lens group G2 will be described. The fourth lens L4 is a biconvex lens. The fifth lens L5 is a biconcave lens. The sixth lens L6 is a biconcave lens. The seventh lens L7 is a meniscus lens having a convex surface facing the object. The eighth lens L8 is a meniscus lens having a convex surface facing the object.

Next, the respective lenses that form the third lens group G3 will be described. The ninth lens L9 is a biconvex lens. The tenth lens L10 is a biconvex lens. The eleventh lens L11 is a biconcave lens.

Next, the respective lenses that form the fourth lens group G4 will be described. The twelfth lens L12 is a biconcave lens. The thirteenth lens L13 is a biconvex lens.

Next, the respective lenses that form the fifth lens group G5 will be described. The fourteenth lens L14 is a biconvex lens. The fifteenth lens L15 is a biconcave lens.

Next, the respective lenses that form the sixth lens group G6 will be described. The sixteenth lens L16 is a biconvex lens. The seventeenth lens L17 is a meniscus lens having a convex surface facing the image plane.

Next, the respective lenses that form the seventh lens group G7 will be described. The eighteenth lens L18 is a biconcave lens. The nineteenth lens L19 is a meniscus lens having a convex surface facing the object.

While the imaging optical system according to the seventh embodiment is zooming from the wide-angle end toward the telephoto end during a shooting session, the first lens group G1, the third lens group G3, the fourth lens group G4, the fifth lens group G5, and the seventh lens group G7 all move toward the object with respect to the image plane S. In the meantime, as the imaging optical system is zooming from the wide-angle end toward the telephoto end during the shooting session, the first, second, third, fourth, fifth, sixth, and seventh lens groups G1, G2, G3, G4, G5, G6, G7 move along the optical axis such that the interval between the first lens group G1 and the second lens group G2 increases, the interval between the second lens group G2 and the third lens group G3 decreases, the interval between the third lens group G3 and the fourth lens group G4 decreases and then increases, the interval between the fourth lens group G4 and the fifth lens group G5 increases and then decreases, the interval between the fifth lens group G5 and the sixth lens group G6 increases, the interval between the sixth lens group G6 and the seventh lens group G7 decreases, and the interval between the seventh lens group G7 and the image plane S increases. While the imaging optical system according to the seventh embodiment is focusing to make a transition from the infinity in-focus state toward the close-object in-focus state, the fifth lens group G5 moves along the optical axis toward the image plane.

When any camera shake or any vibration caused by external force during a shooting session is detected by a gyrosensor provided for at least one of an interchangeable lens unit holding the imaging optical system or an image capture device to which the interchangeable lens unit is attached, the sub-lens group G2b (forming a group of image stabilizer lenses) which belong to the second lens group G2 moves perpendicularly to the optical axis (i.e., in a direction in which the image blur is reduced) to optically compensate for the image blur that may be caused by the camera shake or the vibration due to external force. These image blur compensation lenses allow the imaging optical system to compensate for the shift of the image point due to the vibration of the overall system. That is to say, this allows the imaging optical system to optically compensate for the image blur due to camera shake, vibrations, and other disturbances.

### Other Embodiments

The first, second, third, fourth, fifth, sixth, and seventh embodiments have been described as exemplary embodiments of the present disclosure. Note that the embodiments described above are only examples of the present disclosure and should not be construed as limiting. Rather, each of these embodiments may be readily modified, replaced, combined with other embodiments, provided with some additional components, or partially omitted without departing from the scope of the present disclosure.

For example, in the first to seventh embodiments described above, the imaging optical system is supposed to be used in the entire zoom range from the wide-angle end through the telephoto end. However, the imaging optical system does not have to be used in the entire zoom range. Alternatively, the imaging optical system may also be used selectively only in an extracted range where optical performance is ensured according to the desired zoom range, for example. That is to say, the imaging optical system may also be used as an imaging optical system with lower zoom power than the imaging optical system to be described for the first, second, third, fourth, fifth, sixth, and seventh examples of numerical values corresponding to the first, second, third, fourth, fifth, sixth, and seventh embodiments, respectively. Optionally, the imaging optical system may also be used selectively as a single-focus lens system only at an extracted focal length where optical performance is ensured according to the desired zoom position.

In addition, the number of the lens groups and the number of the lenses that form each lens group are substantial numbers. Optionally, a lens having substantially no power may be added to any of the lens groups described above.

In the embodiments described above, the image blur is compensated for by moving the image blur compensation lenses perpendicularly to the optical axis. However, the image blur can be compensated for as long as the lenses are moved such that each of those lenses has a vertical direction component. For example, the image blur may also be compensated for by pivoting the image blur compensation lenses around a center of rotation on the optical axis (i.e., with the lenses tilted such that the axis of each of these lenses intersects with the optical axis of the imaging optical system) if the lens barrel is allowed to have a complicated structure. (Conditions and advantages)

Next, conditions that may be satisfied by the imaging optical systems according to the first to seventh embodiments, for example, will be described. A plurality of possible conditions may be defined for the imaging optical system according to each of the first to seventh embodiments. In that case, an imaging optical system, of which the configuration satisfies all of these possible conditions, is most advantageous. Alternatively, an imaging optical system that achieves its expected advantages by satisfying any of the individual conditions to be described below may also be provided.

An imaging optical system according to each of the first to seventh embodiments consists of: a first lens group G1 having positive power; a second lens group G2 having negative power; a third lens group G3 having positive power; a fourth lens group G4 having positive power; a fifth lens group G5 having negative power; a sixth lens group G6 having positive power; and a seventh lens group G7 having negative power. The first, second, third, fourth, fifth, sixth, and seventh lens groups G1-G7 are arranged in this order such that the first lens group G1 is located closer to an object than any of the second, third, fourth, fifth, sixth, or seventh lens group G2, G3, G4, G5, G6, G7 is and that the seventh lens group G7 is located closer to an image plane than any of the first, second, third, fourth, fifth, or sixth lens groups G1, G2, G3, G4, G5, G6 is. An interval between each pair of lens groups located adjacent to each other which belong to the first through seventh lens groups G1-G7 changes while the imaging optical system is zooming from a wide-angle end toward a telephoto end. The second lens group G2 and the sixth lens group G6 are fixed with respect to the image plane S. This configuration will be hereinafter referred to as a “basic configuration.”

The imaging optical system with the basic configuration has a configuration that may be used effectively to reduce the overall size of the zoom lens. This allows the imaging optical system to compensate for various types of aberrations that occur to the respective lens groups during zooming. Consequently, this allows for providing an imaging optical system having the ability to compensate for various types of aberrations sufficiently over the entire zoom range. For example, in the imaging optical system, the second lens group G2 consists of a sub-lens group G2a and a sub-lens group G2b. The imaging optical system preferably makes image stabilization by moving the sub-lens group G2b perpendicularly to an optical axis.

The imaging optical system preferably satisfies the following inequality (1):

$$0.8 < f 2 b / f 2 < 1.3 \qquad ( 1 )$$

where f2 is a focal length of the second lens group G2, and
f2b is a focal length of the sub-lens group G2b.

The condition expressed by this inequality (1) defines a ratio of the focal length of the sub-lens group G2b to the focal length of the second lens group G2 in the imaging optical system.

Satisfying the condition expressed by this inequality (1) allows for reducing not only a variation in aberration during the image stabilization but also the overall size of the imaging optical system as well.

If the f2b/f2 ratio were less than the lower limit set by this inequality (1), then the negative refractive power of the sub-lens group G2b would be too strong to avoid causing an increase in various types of aberrations (such as spherical aberration and coma aberration, among other things) that occur inside the sub-lens group G2b. This would make it difficult to reduce the variations in various types of aberrations (such as coma aberration and astigmatism, in particular) due to eccentricity during the image stabilization.

Conversely, if the f2b/f2 ratio were greater than the upper limit set by this inequality (1), then the negative refractive power of the sub-lens group G2b would be too weak. In that case, the imaging optical system would move perpendicularly to the optical axis to an increasing degree during the image stabilization, thus causing an increase in the outside diameter of the imaging optical system so significantly as to make it difficult to reduce the overall size and weight of the imaging optical system.

To enhance the advantage described above, the condition(s) expressed by one or both of the following inequalities (la) and (1b) is/are preferably satisfied:

$$0.9 < f 2 b / f 2 \qquad ( 1 a )$$

$$f 2 b / f 2 < 1.2 . \qquad ( 1 b )$$

More preferably, to further enhance the advantage described above, the condition(s) expressed by one or both of the following inequalities (1c) and (1d) is/are satisfied:

$$0.95 < f 2 b / f 2 \qquad ( 1 c )$$

$$f 2 b / f 2 < 1 \text{.15} . \qquad ( 1 d )$$

For example, in the imaging optical system, the fifth lens group G5 consists of a positive lens and a negative lens which are arranged in this order such that the positive lens is located closer to the object than the negative lens is and that the negative lens is located closer to the image plane than the positive lens is. The fifth lens group G5 moves toward the image plane while the imaging optical system is focusing to make a transition from an infinity in-focus state toward a close-object in-focus state.

The imaging optical system preferably satisfies the following inequality (2):

$$- 11 < ( 1 - β TF \times β TF ) \times ( β TR \times β TR ) < - 7 \qquad ( 2 )$$

where βTF is a lateral magnification of the fifth lens group G5 when the imaging optical system is in the infinity in-focus state at the telephoto end, and
βTR is a composite lateral magnification of all lens groups, located closer to the image plane than the fifth lens group G5 is, of the imaging optical system when the imaging optical system is in the infinity in-focus state at the telephoto end.

The condition expressed by this inequality (2) defines a preferred range of the focus position sensitivity of a focal lens group in an imaging optical system.

Satisfying the condition expressed by this inequality (2) allows for setting the focus position sensitivity of a focus lens group appropriately.

If (1−βTF×βTF)×(βTR×βTR) were less than the lower limit set by this inequality (2), then the focus lens group would have so high position sensitivity as to make it difficult to control the focus lens group, which is not beneficial.

Conversely, if (1−βTF×βTF)×(βTR×βTR) were greater than the upper limit set by the inequality (2), then the focus lens group would move so much as to cause an increase in the overall size of the imaging optical system, which is not beneficial, either.

To enhance the advantage described above, the condition(s) expressed by one or both of the following inequalities (2a) and (2b) is/are preferably satisfied:

$$- 10.2 < ( 1 - β TF \times β TF ) \times ( β TR \times β TR ) \qquad ( 2 a )$$

$$( 1 - β TF \times β TF ) \times ( β TR \times β TR ) < - 7.8 . \qquad ( 2 b )$$

More preferably, to further enhance the advantage described above, the condition(s) expressed by one or both of the following inequalities (2c) and (2d) is/are satisfied:

$$- 9.5 < ( 1 - β TF \times β TF ) \times ( β TR \times β TR ) \qquad ( 2 c )$$

$$( 1 - β TF \times β TF ) \times ( β TR \times β TR ) < - 8.5 . \qquad ( 2 d )$$

For example, the imaging optical system preferably satisfies the following inequality (3):

$$0.16 < BFw / fW < 0.3 \qquad ( 3 )$$

where BFw is an interval measured on an optical axis and at the wide-angle end from a lens located closest to the image plane to the image plane, and
fW is a focal length of the overall imaging optical system when the imaging optical system is in an infinity in-focus state at the wide-angle end.

The condition expressed by this inequality (3) defines a ratio of a back focus (i.e., the interval measured on the optical axis from a lens located closest to the image plane to the image plane S) of the imaging optical system at a wide-angle end to the focal length of the overall imaging optical system when the imaging optical system is in the infinity in-focus state at the wide-angle end

Satisfying the condition expressed by this inequality (3) allows for not only compensating for various types of aberrations sufficiently over the entire zoom range but also reducing the overall size of the imaging optical system as well.

If the BFw/fW ratio were less than the lower limit set by this inequality (3), then the back focus would decrease so much at the wide-angle end as to cause an increase in the outside diameter of the last lens, which is not beneficial.

Conversely, if the BFw/fW ratio were greater than the upper limit set by this inequality (3), then the back focus would increase so much at the wide-angle end as to not only cause an increase in the overall size of the imaging optical system but also make it difficult to compensate for various types of aberrations such as chromatic aberration of magnification, among other things, which is not beneficial, either.

To enhance the advantage described above, the condition(s) expressed by one or both of the following inequalities (3a) and (3b) is/are preferably satisfied:

$$0.18 < BFw / fW \qquad ( 3 a )$$

$$BFw / fW < 0 \text{.28} . \qquad ( 3 b )$$

More preferably, to further enhance the advantage described above, the condition(s) expressed by one or both of the following inequalities (3c) and (3d) is/are satisfied:

$$0.2 < BFw / fW \qquad ( 3 c )$$

$$BFw / fW < 0 \text{.26} . \qquad ( 3 d )$$

For example, the imaging optical system preferably satisfies the following inequality (4):

$$0.1 < f 1 / fT < 0.6 \qquad ( 4 )$$

where f1 is a focal length of the first lens group G1, and fT is a focal length of the overall imaging optical system when the imaging optical system is in an infinity in-focus state at the telephoto end.

The condition expressed by this inequality (4) defines a ratio of the focal length of the first lens group G1 to the focal length of the overall imaging optical system when the imaging optical system is in an infinity in-focus state at the telephoto end.

Satisfying the condition expressed by this inequality (4) allows for not only compensating for various types of aberrations sufficiently over the entire zoom range but also reducing the overall size of the imaging optical system as well.

If the f1/fT ratio were less than the lower limit set by this inequality (4), then the focal length of the first lens group G1 would be so short for the focal length of the overall imaging optical system when the imaging optical system is in the infinity in-focus state at the telephoto end that the synthesis system from the second lens group and on would have too high a magnification of imaging at the telephoto end. This would make it difficult to compensate for various types of aberrations (such as axial chromatic aberration at the telephoto end, among other things), which is not beneficial.

Conversely, if the f1/fT ratio were greater than the upper limit set by this inequality (4), then the focal length of the first lens group G1 would be so long for the focal length of the overall imaging optical system when the imaging optical system is in the infinity in-focus state at the telephoto end that the first lens group G1 would have to move a longer distance while the imaging optical system is zooming from the wide-angle end toward the telephoto end. This would make it difficult to reduce the overall size of the imaging optical system.

To enhance the advantage described above, the condition(s) expressed by one or both of the following inequalities (4a) and (4b) is/are preferably satisfied:

$$0.2 < f 1 / fT \qquad ( 4 a )$$

$$f 1 / fT < 0.5 . \qquad ( 4 b )$$

More preferably, to further enhance the advantage described above, the condition(s) expressed by one or both of the following inequalities (4c) and (4d) is/are satisfied:

$$0.3 < f 1 / fT \qquad ( 4 c )$$

$$f 1 / fT < 0.4 . \qquad ( 4 d )$$

This allows the planarity of the image plane S to be corrected sufficiently over the entire zoom range.

For example, the imaging optical system preferably satisfies the following inequality (5):

$$0.5 < f 3 / f 4 < 1.1 \qquad ( 5 )$$

where f3is a focal length of the third lens group G3, and f4 is a focal length of the fourth lens group G4.

The condition expressed by this inequality (5) defines a ratio of the focal length of the third lens group G3 to the focal length of the fourth lens group G4.

If the f3/f4 ratio were less than the lower limit set by this inequality (5), then the focal length of the third lens group G3 would be so short that it would be difficult to compensate for various types of aberrations such as spherical aberration and axial chromatic aberration at the telephoto end, among other things, which is not beneficial.

Conversely, if the f3/f4 ratio were greater than the upper limit set by this inequality (5), then the focal length of the third lens group G3 would be so long that the third lens group G3 would have to move a longer distance while the imaging optical system is zooming from the wide-angle end toward the telephoto end. This would make it difficult to reduce the overall size of the imaging optical system, which is not beneficial, either.

To enhance the advantage described above, the condition(s) expressed by one or both of the following inequalities (5a) and (5b) is/are preferably satisfied:

$$0.6 < f 3 / f 4 \qquad ( 5 a )$$

$$f 3 / f 4 < 1. . \qquad ( 5 b )$$

More preferably, to further enhance the advantage described above, the condition(s) expressed by one or both of the following inequalities (5c) and (5d) is/are satisfied:

$$0.7 < f 3 / f 4 \qquad ( 5 c )$$

$$f 3 / f 4 < 0.9 . \qquad ( 5 d )$$

For example, the imaging optical system preferably satisfies the following inequality (6):

$$0.08 < f 6 / fT < 0.2 \qquad ( 6 )$$

where f6 is a focal length of the sixth lens group G6, and fT is a focal length of the overall imaging optical system when the imaging optical system is in an infinity in-focus state at the telephoto end.

The condition expressed by this inequality (6) defines a ratio of the focal length of the sixth lens group G6 to the focal length of the overall imaging optical system when the imaging optical system is in an infinity in-focus state at the telephoto end.

If the f6/fT ratio were less than the lower limit set by this inequality (6), then the focal length of the sixth lens group G6 would be so short that it would be difficult to compensate for various types of aberrations such as chromatic aberration of magnification, among other things, which is not beneficial.

Conversely, if the f6/fT ratio were greater than the upper limit set by this inequality (6), then the focal length of the sixth lens group G6 would be so long that the sixth lens group G6 would have to move a longer distance while the imaging optical system is zooming from the wide-angle end toward the telephoto end. This would make it difficult to reduce the overall size of the imaging optical system, which is not beneficial, either.

To enhance the advantage described above, the condition(s) expressed by one or both of the following inequalities (6a) and (6b) is/are preferably satisfied:

$$0.1 < f 6 / fT \qquad ( 6 a )$$

$$f 6 / fT < 0.18 . \qquad ( 6 b )$$

More preferably, to further enhance the advantage described above, the condition(s) expressed by one or both of the following inequalities (6c) and (6d) is/are satisfied:

$$0.12 < f 6 / fT \qquad ( 6 c )$$

$$f 6 / fT < 0.16 . \qquad ( 6 d )$$

For example, in the imaging optical system, the seventh lens group G7 preferably consists of a negative lens and a positive lens which are arranged in this order such that the negative lens is located closer to the object than the positive lens is and that the positive lens is located closer to the image plane than the negative lens is.

The imaging optical system preferably satisfies the following inequality (7):

$$- 0.18 < f 7 / fT < - 0.06 \qquad ( 7 )$$

where f7 is a focal length of the seventh lens group.

The condition expressed by this inequality (7) defines a ratio of the focal length of the seventh lens group G7 to the focal length of the overall imaging optical system when the imaging optical system is in an infinity in-focus state at the telephoto end.

If the f7/fT ratio were less than the lower limit set by this inequality (7), then the focal length of the seventh lens group G7 would be so short that the spherical aberration and coma aberration would vary significantly while the imaging optical system is zooming, which is not beneficial.

Conversely, if the f7/fT ratio were greater than the upper limit set by this inequality (7), then the focal length of the seventh lens group G7 would be so long that the seventh lens group G7 would have to move a longer distance while the imaging optical system is zooming from the wide-angle end toward the telephoto end. This would make it difficult to reduce the overall size of the imaging optical system, which is not beneficial.

To enhance the advantage described above, the condition(s) expressed by one or both of the following inequalities (7a) and (7b) is/are preferably satisfied:

$$- 0.16 < f 7 / fT \qquad ( 7 a )$$

$$f 7 / fT < - 0.08 . \qquad ( 7 b )$$

More preferably, to further enhance the advantage described above, the condition(s) expressed by one or both of the following inequalities (7c) and (7d) is/are satisfied:

$$- 0.14 < f 7 / fT \qquad ( 7 c )$$

$$f 7 / fT < - 0.1 . \qquad ( 7 d )$$

For example, in the imaging optical system, the first lens group G1 preferably consists of a negative lens, a first positive lens, and a second positive lens which are arranged in this order such that the negative lens is located closer to the object than any one of the first and second positive lenses is and that the second positive lens is located closer to the image plane than the negative lens or the first positive lens is. This allows for compensating for various types of aberrations (such as spherical aberration and axial chromatic aberration, among other things) sufficiently.

For example, the imaging optical system preferably satisfies the following inequality (8):

$$1.85 < nd\_ 3 Gn < 2.15 \qquad ( 8 )$$

where nd_3Gn is a refractive index in response to a d-line of a negative lens belonging to the third lens group G3.

The condition expressed by this inequality (8) defines a refractive index in response to a d-line of a negative lens belonging to the third lens group G3.

If nd_3Gn were lower than the lower limit set by this inequality (8), then the refractive index of the negative lens belonging to the third lens group G3 would decrease so much as to make it difficult to compensate for various types of aberrations (such as field curvature, among other things), which is not beneficial.

Conversely, if nd_3Gn were greater than the upper limit set by this inequality (8), then the refractive index of the negative lens belonging to the third lens group G3 would increase so much as to cause a decrease in the transmittance of light, which is not beneficial, either.

To enhance the advantage described above, the condition(s) expressed by one or both of the following inequalities (8a) and (8b) is/are preferably satisfied:

$$1.9 < nd\_ 3 Gn \qquad ( 8 a )$$

$$nd\_ 3 Gn < 2.1 . \qquad ( 8 b )$$

More preferably, to further enhance the advantage described above, the condition(s) expressed by one or both of the following inequalities (8c) and (8d) is/are satisfied:

$$1.95 < nd\_ 3 Gn \qquad ( 8 c )$$

$$nd\_ 3 Gn < 2.05 . \qquad ( 8 d )$$

For example, the imaging optical system preferably satisfies the following inequality (9):

$$1.85 < nd\_ 4 Gn < 2.15 \qquad ( 9 )$$

where nd_4Gn is a refractive index in response to a d-line of a negative lens belonging to the fourth lens group G4.

The condition expressed by this inequality (9) defines a refractive index in response to a d-line of a negative lens belonging to the fourth lens group G4 in the imaging optical system.

If nd_4Gn were lower than the lower limit set by this inequality (9), then the refractive index of the negative lens belonging to the fourth lens group G4 would decrease so much as to make it difficult to compensate for various types of aberrations (such as field curvature, among other things), which is not beneficial.

Conversely, if nd_4Gn were greater than the upper limit set by this inequality (9), then the refractive index of the negative lens belonging to the fourth lens group G4 would increase so much as to cause a decrease in the transmittance of light, which is not beneficial.

To enhance the advantage described above, the condition(s) expressed by one or both of the following inequalities (9a) and (9b) is/are preferably satisfied:

$$1.9 < nd\_ 4 Gn \qquad ( 9 a )$$

$$nd\_ 4 Gn < 2.1 . \qquad ( 9 b )$$

More preferably, to further enhance the advantage described above, the condition(s) expressed by one or both of the following inequalities (9c) and (9d) is/are satisfied:

$$1.95 < nd\_ 4 Gn \qquad ( 9 c )$$

$$nd\_ 4 Gn < 2.05 . \qquad ( 9 d )$$

For example, in the imaging optical system, the sub-lens group G2a preferably consists of a positive lens and a negative lens which are arranged in this order such that the positive lens is located closer to the object than the negative lens is and that the negative lens is located closer to the image plane than the positive lens is.

The imaging optical system preferably satisfies the following inequality (10):

$$20 < vd\_ 2 ap < 30 \qquad ( 10 )$$

where vd_2ap is an abbe number in response to a d-line of the positive lens belonging to the sub-lens group G2a.

The condition expressed by this inequality (10) defines an abbe number in response to a d-line of a positive lens belonging to the sub-lens group G2a in the imaging optical system.

If vd_2ap were less than the lower limit set by this inequality (10), then it would be difficult to compensate for various types of aberrations (such as chromatic aberration of magnification at the wide-angle end, among other things), which is not beneficial.

Conversely, if vd_2ap were greater than the upper limit set by this inequality (10), then it would be difficult to compensate for various types of aberrations (such as chromatic aberration of magnification at the telephoto end, among other things), which is not beneficial, either.

To enhance the advantage described above, the condition(s) expressed by one or both of the following inequalities (10a) and (10b) is/are preferably satisfied:

$$22 < vd\_ 2 ap \qquad ( 10 a )$$

$$vd\_ 2 ap < 28. \qquad ( 10 b )$$

More preferably, to further enhance the advantage described above, the condition(s) expressed by one or both of the following inequalities (10c) and (10d) is/are satisfied:

$$24 < vd\_ 2 ap \qquad ( 10 c )$$

$$vd\_ 2 ap < 26. \qquad ( 10 d )$$

(Schematic Configuration for Image Capture Device to which First Embodiment is Applied)

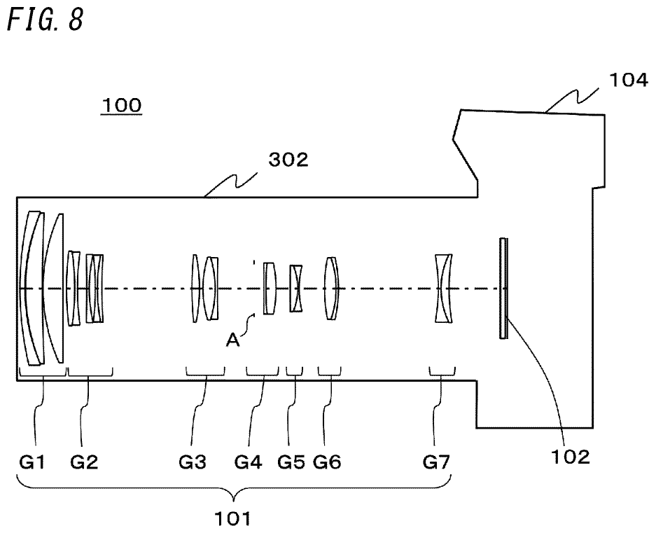

FIG. 8 illustrates a schematic configuration for an image capture device, to which the imaging optical system of the first embodiment is applied. Alternatively, the imaging optical system according to the second, third, fourth, fifth, sixth, or seventh embodiment is also applicable to the image capture device.

The image capture device 100 includes a housing 104, an image sensor 102, and the imaging optical system 101 according to the first embodiment. Specifically, the image capture device 100 may be implemented as a digital camera, for example.

The housing 104 includes a lens barrel 302. The lens barrel 302 holds the respective lens groups and the aperture stop A that form the imaging optical system 101.

The image sensor 102 is disposed at the image plane S of the imaging optical system according to the first embodiment.

In the imaging optical system 101, the first lens group G1, the second lens group G2, the third lens group G3, the fourth lens group G4, the fifth lens group G5, the sixth lens group G6, and the seventh lens group G7 are attached to, or engaged with, a lens frame included in the lens barrel 302 such that the interval between each pair of lenses located adjacent to each other which belong to these lens groups changes while the imaging optical system 101 is zooming from the wide-angle end toward the telephoto end.

In addition, an actuator and a lens frame to be controlled by a controller in the lens barrel 302 are configured to allow the fifth lens group G5 to move while the imaging optical system is focusing.

This allows for providing an image capture device with the ability to compensate for various types of aberrations sufficiently.

In the example described above, the imaging optical system according to the first embodiment is applied to a digital camera. However, this is only an example and should not be construed as limiting. Alternatively, the imaging optical system is also applicable to a surveillance camera, a smartphone, or any of various other types of image capture devices.

(Schematic Configuration for Camera System to which First Embodiment is Applied)

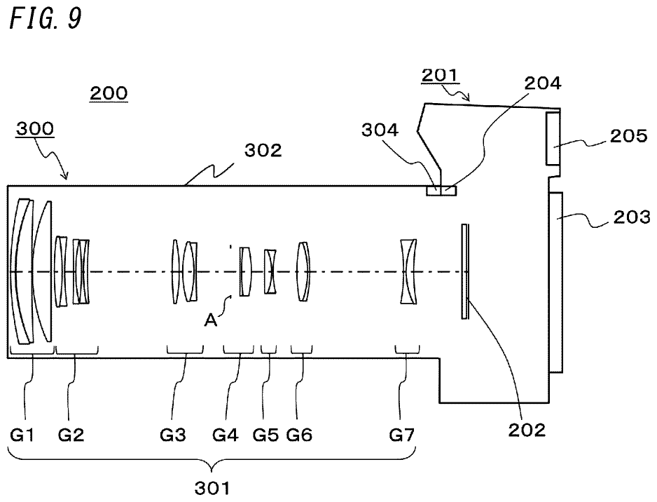

FIG. 9 illustrates a schematic configuration for a camera system, to which the imaging optical system of the first embodiment is applied. Alternatively, the imaging optical system according to the second, third, fourth, fifth, sixth or seventh embodiment is also applicable to the camera system.

The camera system 200 includes a camera body 201 and an interchangeable lens unit 300 to be connected removably to the camera body 201.

The camera body 201 includes an image sensor 202, a monitor 203, a memory, a camera mount 204, and a viewfinder 205. The image sensor 202 receives an optical image formed by the imaging optical system 301 of the interchangeable lens unit 300 and transforms the optical image into an electrical image signal. The monitor 203 displays the image signal transformed by the image sensor 202. The memory stores the image signal.

The imaging optical system 301 of the interchangeable lens unit 300 is the imaging optical system according to the first embodiment.

The interchangeable lens unit 300 includes not only the imaging optical system 301 but also a lens barrel 302 and a lens mount 304 as well. The lens barrel 302 holds the respective lens groups and aperture stop A that form the imaging optical system 301. The lens mount 304 is to be connected to the camera mount 204 of the camera body 201.

The camera mount 204 and the lens mount 304 are physically connected together. In addition, the camera mount 204 and the lens mount 304 also electrically connect together a controller in the camera body 201 and a controller in the interchangeable lens unit 300. That is to say, the camera mount 204 and the lens mount 304 serve as interfaces that allow themselves to exchange signals with each other.

In the imaging optical system 301, the first lens group G1, the second lens group G2, the third lens group G3, the fourth lens group G4, the fifth lens group G5, the sixth lens group G6, and the seventh lens group G7 are attached to, or engaged with, a lens frame included in the lens barrel 302 so that the interval between each pair of lens groups located adjacent to each other which belong to these lens groups may be changed while the imaging optical system 301 is zooming from the wide-angle end toward the telephoto end.

In the camera system 200 including the respective lens groups held by the lens barrel 302 and the camera body 201, an actuator, a lens frame, and other members to be controlled by the controller in the interchangeable lens unit 300 are provided such that the fifth lens group G5 may move while the imaging optical system 301 is focusing. (Examples of numerical values)

Next, exemplary sets of specific numerical values that were actually adopted in the imaging optical systems with the configurations according to the first, second, third, fourth, fifth, sixth, and seventh embodiments will be described. Note that in the tables showing these exemplary sets of numerical values, the length is expressed in millimeters (mm), the angle of view is expressed in degrees) (°), r indicates the radius of curvature, d indicates the surface interval, nd indicates a refractive index in response to a d-line, vd (also denoted as “vd”) indicates an abbe number in response to a d-line, and a surface with an asterisk (*) is an aspheric surface. The aspheric shape is defined by the following equation:

$$Z = \frac{{h}^{2} / r}{1 + \sqrt{1 - ( 1 + κ ) {( h / r )}^{2}}} + \sum {A}_{n} {h}^{n}$$

where Z is the distance from a point on an aspheric surface, located at a height h measured from the optical axis, to a tangent plane defined with respect to the vertex of the aspheric surface, h is the height as measured from the optical axis, r is the radius of curvature of the vertex, K is a conic constant, and An is an n^{th} order aspheric surface coefficient.

FIGS. 1B, 2B, 3B, 4B, 5B, 6B, and 7B are longitudinal aberration diagrams showing what state the imaging optical systems according to the first, second, third, fourth, fifth, sixth, and seventh embodiments assume.

In each longitudinal aberration diagram, portion (a) shows the longitudinal aberrations at the wide-angle end, portion (b) shows the longitudinal aberrations at the middle position, and portion (c) shows the longitudinal aberrations at the telephoto end. Each of portions (a), (b) and (c) of these longitudinal aberration diagrams shows spherical aberration (SA (mm)), astigmatism (AST (mm)), and distortion (DIS (%)) in this order from left to right. In each spherical aberration diagram, the ordinate indicates the F number (designated by “F” on the drawings), the solid curve indicates a characteristic in response to a d-line, the shorter dashed curve indicates a characteristic in response to an F-line, and the longer dashed curve indicates a characteristic in response to a C-line. In each astigmatism diagram, the ordinate indicates the image height (designated by “H” on the drawings), the solid curve indicates a characteristic with respect to a sagittal plane (designated by “s” on the drawings), and the dotted curve indicates a characteristic with respect to a meridional plane (designated by “m” on the drawings). Furthermore, in each distortion diagram, the ordinate indicates the image height (designated by “H” on the drawings).

FIGS. 1C, 2C, 3C, 4C, 5C, 6C, and 7C are lateral aberration diagrams showing what state the imaging optical systems according to the first, second, third, fourth, fifth, sixth, and seventh embodiments assume at the telephoto end.

In each lateral aberration diagram, the upper three aberration diagrams represent a basic state where no image blur compensation is performed at the telephoto end. On the other hand, the lower three aberration diagrams represent an image blur compensated state where the group of image stabilizer lenses is moved to a predetermined degree perpendicularly to the optical axis at the telephoto end. In the three lateral aberration diagrams representing the basic state, the upper graph shows lateral aberration at an image point corresponding to 70% of the maximum image height. The middle graph shows the lateral aberration at an axial image point. The lower graph shows lateral aberration at an image point corresponding to −70% of the maximum image height. In the three lateral aberration diagrams representing the image blur compensated state, the upper graph shows lateral aberration at an image point corresponding to 70% of the maximum image height. The middle graph shows lateral aberration at an axial image point. The lower graph shows lateral aberration at an image point corresponding to −70% of the maximum image height. Also, in each lateral aberration diagram, the abscissa indicates the distance from a principal ray on the pupil plane. The solid curve indicates a characteristic in response to a d-line. The shorter dashed curve indicates a characteristic in response to an F-line. The longer dashed curve indicates a characteristic in response to a C-line.

Note that in the imaging optical systems according to the respective examples of numerical values, the magnitudes of movement of the group of image blur compensation lenses in a direction perpendicular to the optical axis at the telephoto end are as follows:
First example of numerical values: 0.738 mm
Second example of numerical values: 0.806 mm
Third example of numerical values: 0.683 mm
Fourth example of numerical values: 0.921 mm
Fifth example of numerical values: 0.806 mm
Sixth example of numerical values: 0.806 mm
Seventh example of numerical values: 0.806 mm

At the telephoto end at which the shooting distance is infinite (∞), the magnitude of image eccentricity in a situation where the imaging optical system is tilted to 0.3 degrees is equal to the magnitude of image eccentricity in a situation where the group of image blur compensation lenses makes parallel displacement by a distance represented by any of these numerical values in a direction perpendicular to the optical axis.

As can be seen from these lateral aberration diagrams, the lateral aberration at the axial image point has a sufficient degree of symmetry. It can also be seen that comparing the lateral aberration at an image point corresponding to +70% of the maximum image height with the lateral aberration at an image point corresponding to −70% of the maximum image height in the basic state, their degrees of curvature are both small and their aberration curves have an approximately equal tilt, and therefore, their eccentricity coma aberration and eccentricity astigmatism are both insignificant. This means that even in the image blur compensated state, sufficiently good imaging performance is achieved. In addition, supposing the imaging optical systems have the same image blur compensation angle, as the focal length of the overall imaging optical system shortens, the magnitude of parallel displacement required for image blur compensation decreases. This allows the image blur compensation to be done to a sufficient degree at any zoom position with respect to an image blur compensation angle of about 0.3 degrees without causing a decline in imaging performance.

(First example of numerical values)

Following is a first exemplary set of numerical values for the imaging optical system corresponding to the first embodiment shown in FIG. 1A. Specifically, as the first example of numerical values for the imaging optical system, surface data is shown in Table 1A, aspheric surface data is shown in Table 1B, and various types of data in the infinity in-focus state are shown in Tables 1C-1F.

TABLE 1A
(Surface data)

| Surface No. | r | | | |
|---|---|---|---|---|
| Object surface | ∞ | d | nd | vd |
| 1 | 146.05180 | 2.20000 | 1.83481 | 42.7 |
| 2 | 85.08960 | 0.30000 | | |
| 3 | 88.63860 | 7.41070 | 1.43700 | 95.1 |
| 4 | 757.12520 | 0.30000 | | |
| 5 | 79.51600 | 8.76930 | 1.43700 | 95.1 |
| 6 | ∞ | Variable | | |
| 7 | 129.63500 | 3.63600 | 1.85451 | 25.2 |
| 8 | −115.64990 | 0.01000 | 1.56732 | 42.8 |
| 9 | −115.64990 | 1.20000 | 1.83400 | 37.3 |
| 10 | 118.18150 | 4.10500 | | |
| 11 | −510.39340 | 1.10000 | 1.72916 | 54.7 |
| 12 | 68.31050 | 2.65380 | | |
| 13 | −118.91230 | 0.90000 | 1.49700 | 81.6 |
| 14 | 77.31990 | 0.01000 | 1.56732 | 42.8 |
| 15 | 77.31990 | 1.95520 | 1.80809 | 22.8 |
| 16 | 203.53620 | Variable | | |
| 17 | 143.79420 | 3.31330 | 1.80420 | 46.5 |
| 18 | −76.44480 | 1.59080 | | |
| 19 | 48.42100 | 5.29970 | 1.43700 | 95.1 |
| 20 | −48.42100 | 0.01000 | 1.56732 | 42.8 |
| 21 | −48.42100 | 1.00000 | 2.05090 | 26.9 |
| 22 | 419.43030 | Variable | | |
| 23 (Aperture) | ∞ | 4.33140 | | |
| 24 | −713.21390 | 0.80000 | 2.00069 | 25.5 |
| 25 | 114.08840 | 0.01000 | 1.56732 | 42.8 |
| 26 | 114.08840 | 4.49120 | 1.73037 | 32.2 |
| 27 | −54.81050 | Variable | | |
| 28 | 1245.70520 | 3.35910 | 1.73037 | 32.2 |
| 29 | −26.61610 | 0.01000 | 1.56732 | 42.8 |
| 30 | −26.61610 | 0.60000 | 1.70154 | 41.1 |
| 31 | 39.16700 | Variable | | |
| 32 | 70.08010 | 5.02930 | 1.56732 | 42.8 |
| 33 | −40.82180 | 0.01000 | 1.56732 | 42.8 |
| 34 | −40.82180 | 1.00000 | 1.80610 | 33.3 |
| 35 | −62.10300 | Variable | | |
| 36 | −81.79000 | 1.20000 | 1.74400 | 44.8 |
| 37 | 33.68260 | 0.01000 | 1.56732 | 42.8 |
| 38 | 33.68260 | 3.54170 | 1.77047 | 29.7 |
| 39 | 88.21410 | Variable | | |
| 40 | ∞ | 2.10000 | 1.51680 | 64.2 |
| 41 | ∞ | 1.00000 | | |
| Image plane | ∞ | | | |

### (Table 1B: Aspheric Surface Data)

In this embodiment, there are no surfaces that are aspheric surfaces.

TABLE 1C
(Various types of data in infinity in−focus state)
(Various types of data)
Zoom ratio: 4.64197

| | Wide−angle | Middle | Telephoto |
|---|---|---|---|
| Focal length | 103.7170 | 223.4935 | 481.4513 |
| F number | 5.24558 | 6.52617 | 7.34838 |
| Angle of view | 11.6554 | 5.4576 | 2.5299 |
| Image height | 21.6300 | 21.6300 | 21.6300 |
| Total lens length | 214.3996 | 262.6363 | 294.2207 |
| d6 | 1.5000 | 49.7366 | 81.3209 |
| d16 | 39.6200 | 24.7691 | 2.0000 |
| d22 | 16.1820 | 10.3386 | 17.5127 |
| d27 | 6.1968 | 10.7947 | 2.0290 |
| d31 | 11.1553 | 27.2518 | 51.6125 |
| d35 | 43.9285 | 21.8038 | 1.8000 |
| d39 | 22.5605 | 44.6852 | 64.6891 |
| Entrance pupil position | 81.8616 | 215.0681 | 437.0218 |
| Exit pupil position | −61.5790 | −91.2134 | −124.3783 |
| Anterior principal point | 11.0150 | −108.5639 | −946.2412 |
| Posterior principal point | 110.7271 | 39.2235 | −187.3029 |

TABLE 1D
(Data about single lenses)

| Lens | Start surface | Focal length |
|---|---|---|
| 1 | 1 | −248.2714 |
| 2 | 3 | 228.9569 |
| 3 | 5 | 181.9584 |
| 4 | 7 | 72.0209 |
| 5 | 9 | −69.9219 |
| 6 | 11 | −82.5591 |
| 7 | 13 | −94.1311 |
| 8 | 15 | 153.2364 |
| 9 | 17 | 62.4819 |
| 10 | 19 | 56.3391 |
| 11 | 21 | −41.2620 |
| 12 | 24 | −98.2394 |
| 13 | 26 | 51.2669 |
| 14 | 28 | 35.7194 |
| 15 | 30 | −22.5043 |
| 16 | 32 | 46.2283 |
| 17 | 34 | −150.9471 |
| 18 | 36 | −31.9253 |
| 19 | 38 | 68.7758 |

TABLE 1E
(Data about zoom lens groups)

| | | | Lens | Anterior | Posterior |
|---|---|---|---|---|---|
| | Start | | configuration | principal | principal |
| Group | surface | Focal length | length | point | point |
| 1 | 1 | 174.13737 | 18.98000 | 5.25422 | 11.09334 |
| 2 | 7 | −61.25908 | 15.57000 | 9.49860 | 13.15424 |
| 3 | 17 | 87.20008 | 11.21380 | −4.89577 | −0.44000 |
| 4 | 23 | 103.19866 | 9.63260 | 8.36583 | 10.70474 |
| 5 | 28 | −61.68471 | 3.96910 | 2.41286 | 4.07824 |
| 6 | 32 | 66.56373 | 6.03930 | 2.01348 | 4.21837 |
| 7 | 36 | −58.00576 | 4.75170 | 1.33112 | 3.41964 |

TABLE 1F
(Zoom powers of zoom lens groups)

| Group | Start surface | Wide−angle | Middle | Telephoto |
|---|---|---|---|---|
| 1 | 1 | 0.00000 | 0.00000 | 0.00000 |
| 2 | 7 | −0.65174 | −1.33881 | −4.32251 |
| 3 | 17 | −1.70566 | −1.11278 | −0.36582 |
| 4 | 23 | 0.34067 | 0.40143 | 0.55854 |
| 5 | 28 | 52.27458 | 5.11953 | 3.16394 |
| 6 | 32 | 0.02070 | 0.22833 | 0.45427 |
| 7 | 36 | 1.45377 | 1.83582 | 2.17805 |

### Second Example of Numerical Values

Following is a second exemplary set of numerical values for the imaging optical system corresponding to the second embodiment shown in FIG. 2A. Specifically, as the second example of numerical values for the imaging optical system, surface data is shown in Table 2A, aspheric surface data is shown in Table 2B, and various types of data in the infinity in-focus state are shown in Tables 2C-2F.

TABLE 2A
(Surface data)

| Surface No. | r | d | nd | vd |
|---|---|---|---|---|
| Object surface | ∞ | | | |
| 1 | 199.53900 | 2.20000 | 1.83481 | 42.7 |
| 2 | 93.61560 | 0.30000 | | |
| 3 | 97.96830 | 7.56330 | 1.49700 | 81.6 |
| 4 | ∞ | 0.30000 | | |
| 5 | 82.28870 | 8.54720 | 1.43700 | 95.1 |
| 6 | ∞ | Variable | | |
| 7 | 145.83190 | 3.82640 | 1.85451 | 25.2 |
| 8 | −107.83310 | 0.01000 | 1.56732 | 42.8 |
| 9 | −107.83310 | 1.20000 | 1.83400 | 37.3 |
| 10 | 117.95330 | 9.84060 | | |
| 11 | −287.62100 | 1.10000 | 1.72916 | 54.7 |
| 12 | 90.82490 | 1.54040 | | |
| 13 | −340.94700 | 0.90000 | 1.59410 | 60.5 |
| 14 | 53.04970 | 0.01000 | 1.56732 | 42.8 |
| 15 | 53.04970 | 2.06200 | 1.85451 | 25.2 |
| 16 | 106.35160 | Variable | | |
| 17 | 211.98460 | 3.13870 | 1.80420 | 46.5 |
| 18 | −66.28980 | 0.20000 | | |
| 19 | 44.58360 | 5.37340 | 1.43700 | 95.1 |
| 20 | −44.58360 | 0.01000 | 1.56732 | 42.8 |
| 21 | −44.58360 | 1.00000 | 2.00100 | 29.1 |
| 22 | 365.69600 | Variable | | |
| 23 (Aperture) | ∞ | 4.50000 | | |
| 24 | −232.47420 | 0.80000 | 2.00069 | 25.5 |
| 25 | 169.54910 | 0.01000 | 1.56732 | 42.8 |
| 26 | 169.54910 | 2.87500 | 1.73037 | 32.2 |
| 27 | −48.21570 | Variable | | |
| 28 | ∞ | 3.21290 | 1.73037 | 32.2 |
| 29 | −26.42410 | 0.01000 | 1.56732 | 42.8 |
| 30 | −26.42410 | 0.60000 | 1.70154 | 41.1 |
| 31 | 39.95230 | Variable | | |
| 32 | 73.56440 | 4.94280 | 1.56732 | 42.8 |
| 33 | −37.62000 | 0.01000 | 1.56732 | 42.8 |
| 34 | −37.62000 | 1.00000 | 1.80610 | 33.3 |
| 35 | −57.38700 | Variable | | |
| 36 | −75.65570 | 1.20000 | 1.74400 | 44.8 |
| 37 | 32.56640 | 0.01000 | 1.56732 | 42.8 |
| 38 | 32.56640 | 3.90700 | 1.77047 | 29.7 |
| 39 | 95.59890 | Variable | | |
| 40 | ∞ | 2.10000 | 1.51680 | 64.2 |
| 41 | ∞ | 1.00000 | | |
| Image plane | ∞ | | | |

### (Table 2B: Aspheric Surface Data)

In this embodiment, there are no surfaces that are aspheric surfaces.

TABLE 2C
(Various types of data in infinity in-focus state)
(Various types of data)
Zoom ratio: 4.65000

| | Wide-angle | Middle | Telephoto |
|---|---|---|---|
| Focal length | 103.5368 | 223.3469 | 481.4459 |
| F number | 5.14529 | 6.42294 | 7.34765 |
| Angle of view | 11.6354 | 5.4454 | 2.5292 |
| Image height | 21.6300 | 21.6300 | 21.6300 |
| Total lens length | 214.3998 | 262.0680 | 294.3997 |
| d6 | 1.5000 | 49.1684 | 81.5000 |
| d16 | 40.1711 | 25.5321 | 2.4695 |
| d22 | 16.3792 | 10.9487 | 14.8526 |
| d27 | 6.3143 | 11.4192 | 2.8405 |
| d31 | 9.2070 | 24.1715 | 51.9089 |
| d35 | 44.3285 | 21.5033 | 1.8000 |
| d39 | 21.2000 | 44.0251 | 63.7285 |
| Entrance pupil position | 89.9508 | 228.1830 | 435.2043 |
| Exit pupil position | −59.4766 | −88.7994 | −124.2914 |
| Anterior principal point | 13.4060 | −109.5373 | −949.3943 |
| Posterior principal point | 110.9143 | 38.8306 | −187.1229 |

TABLE 2D
(Data about single lenses)

| Lens | Start surface | Focal length |
|---|---|---|
| 1 | 1 | −213.2660 |
| 2 | 3 | 197.1204 |
| 3 | 5 | 188.3032 |
| 4 | 7 | 73.0565 |
| 5 | 9 | −67.3829 |
| 6 | 11 | −94.5511 |
| 7 | 13 | −77.2053 |
| 8 | 15 | 121.7017 |
| 9 | 17 | 63.1108 |
| 10 | 19 | 51.9631 |
| 11 | 21 | −39.6507 |
| 12 | 24 | −97.8781 |
| 13 | 26 | 51.6868 |
| 14 | 28 | 36.1790 |
| 15 | 30 | −22.5870 |
| 16 | 32 | 44.5923 |
| 17 | 34 | −138.6184 |
| 18 | 36 | −30.4561 |
| 19 | 38 | 62.4228 |

TABLE 2E
(Data about zoom lens groups)

| | Start | | Lens configuration | Anterior | Posterior |
|---|---|---|---|---|---|
| Group | surface | Focal length | length | principal point | principal point |
| 1 | 1 | 177.09249 | 18.91050 | 5.91802 | 11.97663 |
| 2 | 7 | −60.82376 | 20.48940 | 14.89947 | 18.71196 |
| 3 | 17 | 84.70732 | 9.72210 | −3.93264 | 0.18636 |
| 4 | 23 | 106.13844 | 8.18500 | 7.75915 | 9.41307 |
| 5 | 28 | −60.75012 | 3.82290 | 2.24171 | 3.84867 |
| 6 | 32 | 65.73755 | 5.95280 | 2.12098 | 4.29548 |
| 7 | 36 | −57.83677 | 5.11700 | 1.31708 | 3.56940 |

TABLE 2F
(Zoom powers of zoom lens groups)

| Group | Start surface | Wide-angle | Middle | Telephoto |
|---|---|---|---|---|
| 1 | 1 | 0.00000 | 0.00000 | 0.00000 |
| 2 | 7 | −0.65447 | −1.34367 | −4.70212 |
| 3 | 17 | −1.57040 | −1.04293 | −0.32278 |
| 4 | 23 | 0.36575 | 0.42295 | 0.57051 |
| 5 | 28 | 79.99248 | 5.08963 | 3.19413 |
| 6 | 32 | 0.01355 | 0.22832 | 0.45328 |
| 7 | 36 | 1.43542 | 1.83107 | 2.16853 |

### Third Example of Numerical Values

Following is a third exemplary set of numerical values for the imaging optical system corresponding to the third embodiment shown in FIG. 3A. Specifically, as the third example of numerical values for the imaging optical system, surface data is shown in Table 3A, aspheric surface data is shown in Table 3B, and various types of data in the infinity in-focus state are shown in Tables 3C-3F.

TABLE 3A
(Surface data)

| Surface No. | r | d | nd | vd |
|---|---|---|---|---|
| Object surface | ∞ | | | |
| 1 | 179.18700 | 2.20000 | 1.83481 | 42.7 |
| 2 | 88.86910 | 0.30000 | | |
| 3 | 92.75360 | 7.49370 | 1.49700 | 81.6 |
| 4 | 1411.95210 | 0.30000 | | |
| 5 | 80.80650 | 8.68650 | 1.43700 | 95.1 |
| 6 | −36217.93590 | Variable | | |
| 7 | 233.38680 | 3.09370 | 1.84666 | 23.8 |
| 8 | −128.98370 | 0.01000 | 1.56732 | 42.8 |
| 9 | −128.98370 | 1.20000 | 1.80610 | 33.3 |
| 10 | 259.58780 | 4.26740 | | |
| 11 | −332.92580 | 1.10000 | 1.72916 | 54.7 |
| 12 | 66.93240 | 2.53810 | | |
| 13 | −162.14800 | 0.90000 | 1.59410 | 60.5 |
| 14 | 55.96470 | 0.01000 | 1.56732 | 42.8 |
| 15 | 55.96470 | 2.50710 | 1.85451 | 25.2 |
| 16 | 169.85150 | Variable | | |
| 17 | 153.53120 | 3.50650 | 1.80420 | 46.5 |
| 18 | −72.60560 | 1.58750 | | |
| 19 | 48.08620 | 5.41460 | 1.43700 | 95.1 |
| 20 | −48.08620 | 0.01000 | 1.56732 | 42.8 |
| 21 | −48.08620 | 1.00000 | 2.00100 | 29.1 |
| 22 | 339.35950 | Variable | | |
| 23 (Aperture) | ∞ | 4.50000 | | |
| 24 | −703.42570 | 0.80000 | 2.05090 | 26.9 |
| 25 | 101.50080 | 0.01000 | 1.56732 | 42.8 |
| 26 | 101.50080 | 2.87540 | 1.72047 | 34.7 |
| 27 | −53.41750 | Variable | | |
| 28 | −1349.00030 | 3.19560 | 1.73037 | 32.2 |
| 29 | −25.76990 | 0.01000 | 1.56732 | 42.8 |
| 30 | −25.76990 | 0.60000 | 1.70154 | 41.1 |
| 31 | 41.68530 | Variable | | |
| 32 | 80.09280 | 4.82790 | 1.56732 | 42.8 |
| 33 | −37.49920 | 0.01000 | 1.56732 | 42.8 |
| 34 | −37.49920 | 1.00000 | 1.80610 | 33.3 |
| 35 | −57.14520 | Variable | | |
| 36 | −72.74060 | 1.20000 | 1.74400 | 44.8 |
| 37 | 33.48490 | 0.01000 | 1.56732 | 42.8 |
| 38 | 33.48490 | 4.02070 | 1.77047 | 29.7 |
| 39 | 107.80300 | Variable | | |
| 40 | ∞ | 2.10000 | 1.51680 | 64.2 |
| 41 | ∞ | 1.00000 | | |
| Image plane | ∞ | | | |

### (Table 3B: Aspheric Surface Data)

In this embodiment, there are no surfaces that are aspheric surfaces.

TABLE 3C
(Various types of data in infinity in-focus state)
(Various types of data)
Zoom ratio: 4.64218

| | Wide-angle | Middle | Telephoto |
|---|---|---|---|
| Focal length | 103.7181 | 223.4873 | 481.4781 |
| F number | 5.14537 | 6.42171 | 7.34885 |
| Angle of view | 11.6206 | 5.4405 | 2.5285 |
| Image height | 21.6300 | 21.6300 | 21.6300 |
| Total lens length | 214.3997 | 263.5550 | 294.3995 |
| d6 | 1.5000 | 50.6554 | 81.4999 |
| d16 | 40.4562 | 26.4454 | 2.0000 |
| d22 | 19.0361 | 13.5876 | 18.7815 |
| d27 | 6.3317 | 10.7911 | 2.4611 |
| d31 | 9.5806 | 24.5805 | 52.1619 |
| d35 | 44.7104 | 21.3695 | 1.8000 |
| d39 | 20.5000 | 43.8408 | 63.4104 |
| Entrance pupil position | 83.5453 | 225.0988 | 436.3083 |
| Exit pupil position | −59.6171 | −89.0419 | −123.9735 |
| Anterior principal point | 6.9687 | −111.8609 | −953.1361 |
| Posterior principal point | 110.7304 | 40.1450 | −187.1447 |

TABLE 3D
(Data about single lenses)

| Lens | Start surface | Focal length |
|---|---|---|
| 1 | 1 | −213.5686 |
| 2 | 3 | 199.3739 |
| 3 | 5 | 184.5133 |
| 4 | 7 | 98.5033 |
| 5 | 9 | −106.7483 |
| 6 | 11 | −76.3399 |
| 7 | 13 | −69.9225 |
| 8 | 15 | 96.6969 |
| 9 | 17 | 61.7227 |
| 10 | 19 | 55.9768 |
| 11 | 21 | −42.0217 |
| 12 | 24 | −84.3626 |
| 13 | 26 | 48.9581 |
| 14 | 28 | 35.9338 |
| 15 | 30 | −22.6171 |
| 16 | 32 | 45.6996 |
| 17 | 34 | −138.4583 |
| 18 | 36 | −30.6717 |
| 19 | 38 | 61.5918 |

TABLE 3E
(Data about zoom lens groups)

| | Start | | Lens configuration | Anterior | Posterior |
|---|---|---|---|---|---|
| Group | surface | Focal length | length | principal point | principal point |
| 1 | 1 | 175.96655 | 18.98020 | 5.55320 | 11.62012 |
| 2 | 7 | −61.47908 | 15.62630 | 9.16998 | 12.98462 |
| 3 | 17 | 81.86261 | 11.51860 | −4.25484 | 0.26403 |
| 4 | 23 | 112.97252 | 8.18540 | 7.51151 | 9.15283 |
| 5 | 28 | −61.48665 | 3.80560 | 2.15668 | 3.75894 |
| 6 | 32 | 68.27813 | 5.83790 | 2.17471 | 4.31273 |
| 7 | 36 | −59.58614 | 5.23070 | 1.22759 | 3.52921 |

TABLE 3F
(Zoom powers of zoom lens groups)

| Group | Start surface | Wide-angle | Middle | Telephoto |
|---|---|---|---|---|
| 1 | 1 | 0.00000 | 0.00000 | 0.00000 |
| 2 | 7 | −0.63737 | −1.29971 | −3.73562 |
| 3 | 17 | −1.42013 | −0.97047 | −0.39044 |
| 4 | 23 | 0.41338 | 0.46697 | 0.59695 |
| 5 | 28 | 22.47428 | 4.64073 | 3.13657 |
| 6 | 32 | 0.04959 | 0.25733 | 0.47002 |
| 7 | 36 | 1.41343 | 1.80563 | 2.13164 |

### Fourth Example of Numerical Values

Following is a fourth exemplary set of numerical values for the imaging optical system corresponding to the fourth embodiment shown in FIG. 4A. Specifically, as the fourth example of numerical values for the imaging optical system, surface data is shown in Table 4A, aspheric surface data is shown in Table 4B, and various types of data in the infinity in-focus state are shown in Tables 4C-4F.

TABLE 4A
(Surface data)

| Surface No. | r | d | nd | vd |
|---|---|---|---|---|
| Object surface | ∞ | | | |
| 1 | 192.47500 | 2.20000 | 1.83481 | 42.7 |
| 2 | 95.43520 | 0.30000 | | |
| 3 | 99.92370 | 7.36540 | 1.49700 | 81.6 |
| 4 | 4159.45830 | 0.30000 | | |
| 5 | 82.84250 | 8.46480 | 1.43700 | 95.1 |
| 6 | 6324.92620 | Variable | | |
| 7 | 216.53410 | 3.71690 | 1.84666 | 23.8 |
| 8 | −79.19890 | 0.01000 | 1.56732 | 42.8 |
| 9 | −79.19890 | 1.20000 | 1.80610 | 33.3 |
| 10 | 117.99730 | 6.23740 | | |
| 11 | −185.60650 | 1.10000 | 1.72916 | 54.7 |
| 12 | 99.92190 | 0.95480 | | |
| 13 | 613.57660 | 0.90000 | 1.59410 | 60.5 |
| 14 | 48.24590 | 0.01000 | 1.56732 | 42.8 |
| 15 | 48.24590 | 2.18910 | 1.85451 | 25.2 |
| 16 | 99.23610 | Variable | | |
| 17 | 152.66730 | 3.10750 | 1.80420 | 46.5 |
| 18 | −76.19430 | 0.20000 | | |
| 19 | 46.55980 | 5.21320 | 1.43700 | 95.1 |
| 20 | −46.55980 | 0.01000 | 1.56732 | 42.8 |
| 21 | −46.55980 | 1.00000 | 2.00100 | 29.1 |
| 22 | 406.90510 | Variable | | |
| 23 (Aperture) | ∞ | 4.50000 | | |
| 24 | −288.52940 | 0.80000 | 2.05090 | 26.9 |
| 25 | 170.68240 | 0.01000 | 1.56732 | 42.8 |
| 26 | 170.68240 | 2.99740 | 1.72047 | 34.7 |
| 27 | −50.72510 | Variable | | |
| 28 | −3113.76140 | 3.26870 | 1.73037 | 32.2 |
| 29 | −25.95240 | 0.01000 | 1.56732 | 42.8 |
| 30 | −25.95240 | 0.60000 | 1.70154 | 41.1 |
| 31 | 41.28700 | Variable | | |
| 32 | 80.17210 | 4.84600 | 1.56732 | 42.8 |
| 33 | −36.25730 | 0.01000 | 1.56732 | 42.8 |
| 34 | −36.25730 | 1.00000 | 1.80610 | 33.3 |
| 35 | −55.14330 | Variable | | |
| 36 | −69.84620 | 1.20000 | 1.74400 | 44.8 |
| 37 | 32.89050 | 0.01000 | 1.56732 | 42.8 |
| 38 | 32.89050 | 4.07420 | 1.77047 | 29.7 |
| 39 | 107.85200 | Variable | | |
| 40 | ∞ | 2.10000 | 1.51680 | 64.2 |
| 41 | ∞ | 1.00000 | | |
| Image plane | ∞ | | | |

### (Table 4B: Aspheric Surface Data)

In this embodiment, there are no surfaces that are aspheric surfaces.

TABLE 4C
(Various types of data in infinity in-focus state)
(Various types of data)
Zoom ratio: 4.64257

| | Wide-angle | Middle | Telephoto |
|---|---|---|---|
| Focal length | 103.7062 | 223.5160 | 481.4634 |
| F number | 5.14433 | 6.42195 | 7.34792 |
| Angle of view | 11.6203 | 5.4386 | 2.5282 |
| Image height | 21.6300 | 21.6300 | 21.6300 |
| Total lens length | 213.4997 | 261.7567 | 293.4999 |
| d6 | 5.9004 | 54.1573 | 85.9004 |
| d16 | 41.1489 | 26.9212 | 2.3482 |
| d22 | 14.9756 | 9.5295 | 14.2557 |
| d27 | 5.9722 | 10.8964 | 2.0011 |
| d31 | 8.6649 | 23.4146 | 52.1567 |
| d35 | 45.4323 | 21.8582 | 1.8000 |
| d39 | 20.5000 | 44.0741 | 64.1324 |
| Entrance pupil position | 89.3066 | 229.8824 | 428.9099 |
| Exit pupil position | −58.9416 | −88.3734 | −124.1755 |
| Anterior principal point | 10.6846 | −111.3384 | −957.4666 |
| Posterior principal point | 109.8388 | 38.3322 | −188.0346 |

TABLE 4D
(Data about single lenses)

| Lens | Start surface | Focal length |
|---|---|---|
| 1 | 1 | −229.1131 |
| 2 | 3 | 205.8797 |
| 3 | 5 | 192.0072 |
| 4 | 7 | 68.8882 |
| 5 | 9 | −58.6308 |
| 6 | 11 | −88.9358 |
| 7 | 13 | −88.1910 |
| 8 | 15 | 107.7511 |
| 9 | 17 | 63.5871 |
| 10 | 19 | 54.1946 |
| 11 | 21 | −41.6914 |
| 12 | 24 | −101.9572 |
| 13 | 26 | 54.5851 |
| 14 | 28 | 35.8158 |
| 15 | 30 | −22.6317 |
| 16 | 32 | 44.6808 |
| 17 | 34 | −134.5073 |
| 18 | 36 | −29.9060 |
| 19 | 38 | 60.0001 |

TABLE 4E
(Data about zoom lens groups)

| | Start | | Lens configuration | Anterior | Posterior |
|---|---|---|---|---|---|
| Group | surface | Focal length | length | principal point | principal point |
| 1 | 1 | 177.20131 | 18.63020 | 5.47539 | 11.44167 |
| 2 | 7 | −62.41026 | 16.31820 | 10.01445 | 14.04913 |
| 3 | 17 | 83.73245 | 9.53070 | −3.69020 | 0.31083 |
| 4 | 23 | 113.87810 | 8.30740 | 7.87595 | 9.58114 |
| 5 | 28 | −62.04811 | 3.87870 | 2.24109 | 3.87279 |
| 6 | 32 | 66.99002 | 5.85600 | 2.22046 | 4.36374 |
| 7 | 36 | −58.14241 | 5.28420 | 1.20920 | 3.53546 |

TABLE 4F
(Zoom powers of zoom lens groups)

| Group | Start surface | Wide-angle | Middle | Telephoto |
|---|---|---|---|---|
| 1 | 1 | 0.00000 | 0.00000 | 0.00000 |
| 2 | 7 | −0.68068 | −1.43701 | −5.33983 |
| 3 | 17 | −1.37521 | −0.89208 | −0.26763 |
| 4 | 23 | 0.40571 | 0.46352 | 0.60359 |
| 5 | 28 | 47.32800 | 4.84053 | 3.12208 |
| 6 | 32 | 0.02286 | 0.23955 | 0.46431 |
| 7 | 36 | 1.42445 | 1.83070 | 2.17289 |

### Fifth Example of Numerical Values

Following is a fifth exemplary set of numerical values for the imaging optical system corresponding to the fifth embodiment shown in FIG. 5A. Specifically, as the fifth example of numerical values for the imaging optical system, surface data is shown in Table 5A, aspheric surface data is shown in Table 5B, and various types of data in the infinity in-focus state are shown in Tables 5C-5F.

TABLE 5A
(Surface data)

| Surface No. | r | d | nd | vd |
|---|---|---|---|---|
| Object surface | ∞ | | | |
| 1 | 182.99640 | 2.20000 | 1.83481 | 42.7 |
| 2 | 91.75180 | 0.30000 | | |
| 3 | 95.83110 | 7.45750 | 1.49700 | 81.6 |
| 4 | 1645.47830 | 0.30000 | | |
| 5 | 81.54410 | 8.48520 | 1.43700 | 95.1 |
| 6 | 4335.10100 | Variable | | |
| 7 | 128.39020 | 4.01090 | 1.85451 | 25.2 |
| 8 | −112.08400 | 0.01000 | 1.56732 | 42.8 |
| 9 | −112.08400 | 1.20000 | 1.83400 | 37.3 |
| 10 | 107.26130 | 9.68560 | | |
| 11 | −345.10310 | 1.10000 | 1.72916 | 54.7 |
| 12 | 83.51730 | 1.77440 | | |
| 13 | −235.20450 | 0.90000 | 1.59410 | 60.5 |
| 14 | 62.79780 | 0.01000 | 1.56732 | 42.8 |
| 15 | 62.79780 | 1.96660 | 1.85451 | 25.2 |
| 16 | 138.43260 | Variable | | |
| 17 | 183.17620 | 3.19200 | 1.80420 | 46.5 |
| 18 | −67.99260 | 0.20000 | | |
| 19 | 44.82500 | 5.36220 | 1.43700 | 95.1 |
| 20 | −44.82500 | 0.01000 | 1.56732 | 42.8 |
| 21 | −44.82500 | 1.00000 | 2.00100 | 29.1 |
| 22 | 282.34340 | Variable | | |
| 23 (Aperture) | ∞ | 4.50000 | | |
| 24 | −437.75800 | 0.80000 | 2.00069 | 25.5 |
| 25 | 113.72670 | 0.01000 | 1.56732 | 42.8 |
| 26 | 113.72670 | 4.56490 | 1.73037 | 32.2 |
| 27 | −50.19590 | Variable | | |
| 28 | 1629.89800 | 3.10790 | 1.73037 | 32.2 |
| 29 | −27.97090 | 0.01000 | 1.56732 | 42.8 |
| 30 | −27.97090 | 0.60000 | 1.70154 | 41.1 |
| 31 | 40.08680 | Variable | | |
| 32 | 76.18540 | 3.62710 | 1.54814 | 45.8 |
| 33 | −75.23800 | Variable | | |
| 34 | −75.33160 | 1.20000 | 1.74400 | 44.8 |
| 35 | 34.40260 | 0.01000 | 1.56732 | 42.8 |
| 36 | 34.40260 | 3.76640 | 1.77047 | 29.7 |
| 37 | 104.06390 | Variable | | |
| 38 | ∞ | 2.10000 | 1.51680 | 64.2 |
| 39 | ∞ | 1.00000 | | |
| Image plane | ∞ | | | |

### (Table 5B: Aspheric Surface Data)

In this embodiment, there are no surfaces that are aspheric surfaces.

TABLE 5C
(Various types of data in infinity in-focus state)
(Various types of data)
Zoom ratio: 4.69657

| | Wide-angle | Middle | Telephoto |
|---|---|---|---|
| Focal length | 102.5141 | 222.1702 | 481.4640 |
| F number | 5.14538 | 6.42102 | 7.34793 |
| Angle of view | 11.7669 | 5.4851 | 2.5330 |
| Image height | 21.6300 | 21.6300 | 21.6300 |
| Total lens length | 214.4001 | 261.8792 | 294.3998 |
| d6 | 1.5000 | 48.9792 | 81.5000 |
| d16 | 42.1259 | 25.5636 | 2.1767 |
| d22 | 15.4667 | 9.9974 | 15.3229 |
| d27 | 6.2783 | 10.7685 | 2.0010 |
| d31 | 8.7649 | 26.3062 | 53.1350 |
| d33 | 44.6036 | 22.3608 | 1.8000 |
| d37 | 21.2000 | 43.4428 | 64.0035 |
| Entrance pupil position | 91.0083 | 225.9910 | 437.4405 |
| Exit pupil position | −59.7072 | −89.2885 | −124.1769 |
| Anterior principal point | 17.8280 | −104.0867 | −948.2289 |
| Posterior principal point | 111.9937 | 39.7999 | −187.0895 |

TABLE 5D
(Data about single lenses)

| Lens | Start surface | Focal length |
|---|---|---|
| 1 | 1 | −222.8715 |
| 2 | 3 | 204.4177 |
| 3 | 5 | 190.0613 |
| 4 | 7 | 70.5737 |
| 5 | 9 | −65.5561 |
| 6 | 11 | −92.1212 |
| 7 | 13 | −83.3339 |
| 8 | 15 | 132.9151 |
| 9 | 17 | 62.0111 |
| 10 | 19 | 52.2372 |
| 11 | 21 | −38.5858 |
| 12 | 24 | −90.1461 |
| 13 | 26 | 48.2485 |
| 14 | 28 | 37.6805 |
| 15 | 30 | −23.3992 |
| 16 | 32 | 69.6503 |
| 17 | 34 | −31.5961 |
| 18 | 36 | 65.1694 |

TABLE 5E
(Data about zoom lens groups)

| | Start | | Lens configuration | Anterior | Posterior |
|---|---|---|---|---|---|
| Group | surface | Focal length | length | principal point | principal point |
| 1 | 1 | 178.57933 | 18.74270 | 5.37589 | 11.37624 |
| 2 | 7 | −61.67992 | 20.65750 | 15.07900 | 18.83567 |
| 3 | 17 | 87.74919 | 9.76420 | −4.50010 | −0.28821 |
| 4 | 23 | 99.22284 | 9.87490 | 8.80543 | 11.19058 |
| 5 | 28 | −62.50563 | 3.71790 | 2.24283 | 3.80329 |
| 6 | 32 | 69.65025 | 3.62710 | 1.18885 | 2.45303 |
| 7 | 34 | −59.88319 | 4.97640 | 1.21659 | 3.40431 |

TABLE 5F
(Zoom powers of zoom lens groups)

| Group | Start surface | Wide-angle | Middle | Telephoto |
|---|---|---|---|---|
| 1 | 1 | 0.00000 | 0.00000 | 0.00000 |
| 2 | 7 | −0.66355 | −1.35636 | −4.76148 |
| 3 | 17 | −1.61582 | −1.09038 | −0.32851 |
| 4 | 23 | 0.33699 | 0.39095 | 0.54633 |
| 5 | 28 | 15.92164 | 4.53925 | 3.06111 |
| 6 | 32 | 0.07018 | 0.26436 | 0.48287 |
| 7 | 34 | 1.42189 | 1.79305 | 2.13445 |

### Sixth Example of Numerical Values

Following is a sixth exemplary set of numerical values for the imaging optical system corresponding to the sixth embodiment shown in FIG. 6A. Specifically, as the sixth example of numerical values for the imaging optical system, surface data is shown in Table 6A, aspheric surface data is shown in Table 6B, and various types of data in the infinity in-focus state are shown in Tables 6C-6F.

TABLE 6A
(Surface data)

| Surface No. | r | d | nd | vd |
|---|---|---|---|---|
| Object surface | ∞ | | | |
| 1 | 181.80860 | 2.64000 | 1.83481 | 42.7 |
| 2 | 102.89260 | 0.30000 | | |
| 3 | 107.62260 | 7.35900 | 1.43700 | 95.1 |
| 4 | 2006.17260 | 0.36000 | | |
| 5 | 94.98790 | 8.36700 | 1.43700 | 95.1 |
| 6 | −19500.99580 | Variable | | |
| 7 | 948.08950 | 3.04770 | 1.85451 | 25.2 |
| 8 | −103.63710 | 0.01000 | 1.56732 | 42.8 |
| 9 | −103.63710 | 1.20000 | 1.83400 | 37.3 |
| 10 | −10569.98480 | 4.22240 | | |
| 11 | −414.95470 | 1.32000 | 1.72916 | 54.7 |
| 12 | 78.61220 | 2.46170 | | |
| 13 | −174.69870 | 1.08000 | 1.59410 | 60.5 |
| 14 | 67.45880 | 0.01000 | 1.56732 | 42.8 |
| 15 | 67.45880 | 2.39040 | 1.85451 | 25.2 |
| 16 | 212.39620 | Variable | | |
| 17 | 294.54840 | 3.24060 | 1.80420 | 46.5 |
| 18 | −76.38330 | 1.42120 | | |
| 19 | 54.40660 | 5.42940 | 1.43700 | 95.1 |
| 20 | −54.40660 | 0.01000 | 1.56732 | 42.8 |
| 21 | −54.40660 | 1.20000 | 2.00100 | 29.1 |
| 22 | 511.49230 | Variable | | |
| 23 (Aperture) | ∞ | 4.00000 | | |
| 24 | −284.10890 | 0.80000 | 2.00069 | 25.5 |
| 25 | 134.29080 | 0.01200 | 1.56732 | 42.8 |
| 26 | 134.29080 | 2.83840 | 1.73037 | 32.2 |
| 27 | −57.95140 | Variable | | |
| 28 | −3152.61830 | 3.08100 | 1.73037 | 32.2 |
| 29 | −30.24960 | 0.01000 | 1.56732 | 42.8 |
| 30 | −30.24960 | 0.72000 | 1.70154 | 41.1 |
| 31 | 50.43480 | Variable | | |
| 32 | 98.95330 | 3.87340 | 1.56732 | 42.8 |
| 33 | 44.54020 | 0.01000 | 1.56732 | 42.8 |
| 34 | −44.54020 | 1.11570 | 1.80610 | 33.3 |
| 35 | −67.01280 | Variable | | |
| 36 | −77.16830 | 1.20000 | 1.74400 | 44.8 |
| 37 | 36.22610 | 0.01000 | 1.56732 | 42.8 |
| 38 | 36.22610 | 3.79430 | 1.77047 | 29.7 |
| 39 | 126.36980 | Variable | | |
| 40 | ∞ | 2.10000 | 1.51680 | 64.2 |
| 41 | ∞ | 1.20000 | | |
| Image plane | ∞ | | | |

### (Table 6B: Aspheric Surface Data)

In this embodiment, there are no surfaces that are aspheric surfaces.

TABLE 6C
(Various types of data in infinity in-focus state)
(Various types of data)
Zoom ratio: 4.64174

| | Wide-angle | Middle | Telephoto |
|---|---|---|---|
| Focal length | 124.4642 | 268.1635 | 577.7308 |
| F number | 5.76911 | 7.23666 | 8.27965 |
| Angle of view | 9.7254 | 4.5463 | 2.1144 |
| Image height | 21.6300 | 21.6300 | 21.6300 |
| Total lens length | 239.9997 | 297.1724 | 334.9996 |
| d6 | 1.8343 | 59.0071 | 96.8343 |
| d16 | 44.7757 | 28.9973 | 2.1642 |
| d22 | 25.3069 | 18.8175 | 22.9367 |
| d27 | 9.0666 | 14.4122 | 3.4162 |
| d31 | 9.1484 | 26.0705 | 59.7804 |
| d35 | 55.7568 | 26.9847 | 1.8000 |
| d39 | 23.2768 | 52.0489 | 77.2336 |
| Entrance pupil position | 92.9377 | 254.0451 | 503.7952 |
| Exit pupil position | −66.5163 | −100.5096 | −141.3741 |
| Anterior principal point | −15.3342 | −192.7714 | −1280.7271 |
| Posterior principal point | 115.5810 | 29.0779 | −242.8110 |

TABLE 6D
(Data about single lenses)

| Lens | Start surface | Focal length |
|---|---|---|
| 1 | 1 | −288.3424 |
| 2 | 3 | 259.9296 |
| 3 | 5 | 216.3376 |
| 4 | 7 | 109.4781 |
| 5 | 9 | −125.5020 |
| 6 | 11 | −90.5383 |
| 7 | 13 | −81.7803 |
| 8 | 15 | 114.8160 |
| 9 | 17 | 75.7169 |
| 10 | 19 | 63.2091 |
| 11 | 21 | −49.0745 |
| 12 | 24 | −91.0381 |
| 13 | 26 | 55.7741 |
| 14 | 28 | 41.8006 |
| 15 | 30 | −26.8541 |
| 16 | 32 | 54.6747 |
| 17 | 34 | −168.4997 |
| 18 | 36 | −32.9869 |
| 19 | 38 | 64.7278 |

TABLE 6E
(Data about zoom lens groups)

| | Start | | Lens configuration | Anterior | Posterior |
|---|---|---|---|---|---|
| Group | surface | Focal length | length | principal point | principal point |
| 1 | 1 | 202.57815 | 19.02600 | 5.57913 | 11.48438 |
| 2 | 7 | −74.32439 | 15.74220 | 8.90299 | 12.89366 |
| 3 | 17 | 99.87577 | 11.30120 | −4.04839 | 0.27767 |
| 4 | 23 | 138.92564 | 7.65040 | 7.47738 | 9.11527 |
| 5 | 28 | −75.82053 | 3.81100 | 2.20352 | 3.80538 |
| 6 | 32 | 81.27966 | 4.99910 | 1.95487 | 3.82198 |
| 7 | 36 | −65.96566 | 5.00430 | 1.10524 | 3.30164 |

TABLE 6F
(Zoom powers of zoom lens groups)

| Group | Start surface | Wide-angle | Middle | Telephoto |
|---|---|---|---|---|
| 1 | 1 | 0.00000 | 0.00000 | 0.00000 |
| 2 | 7 | −0.67583 | −1.40760 | −4.96328 |
| 3 | 17 | −1.46327 | −0.93459 | −0.29008 |
| 4 | 23 | 0.40724 | 0.47121 | 0.61380 |
| 5 | 28 | 23.14197 | 4.33034 | 2.88041 |
| 6 | 32 | 0.04647 | 0.26583 | 0.50138 |
| 7 | 36 | 1.41854 | 1.85507 | 2.23460 |

### Seventh Example of Numerical Values

Following is a seventh exemplary set of numerical values for the imaging optical system corresponding to the seventh embodiment shown in FIG. 7A. Specifically, as the seventh example of numerical values for the imaging optical system, surface data is shown in Table 7A, aspheric surface data is shown in Table 7B, and various types of data in the infinity in-focus state are shown in Tables 7C-7F.

TABLE 7A
(Surface data)

| Surface No. | r | d | nd | vd |
|---|---|---|---|---|
| Object surface | ∞ | | | |
| 1 | 147.66260 | 2.20000 | 1.83481 | 42.7 |
| 2 | 85.12700 | 0.30000 | | |
| 3 | 89.53180 | 6.66280 | 1.43700 | 95.1 |
| 4 | 1624.78950 | 0.30000 | | |
| 5 | 76.39980 | 7.63190 | 1.43700 | 95.1 |
| 6 | −27405.22370 | Variable | | |
| 7 | 149.23190 | 3.37520 | 1.85451 | 25.2 |
| 8 | −83.74560 | 0.01000 | 1.56732 | 42.8 |
| 9 | −83.74560 | 1.20000 | 1.83400 | 37.3 |
| 10 | 113.24000 | 2.18510 | | |
| 11 | −204.88120 | 1.10000 | 1.72916 | 54.7 |
| 12 | 98.80680 | 0.88180 | | |
| 13 | 1485.68180 | 0.90000 | 1.59410 | 60.5 |
| 14 | 41.51830 | 0.01000 | 1.56732 | 42.8 |
| 15 | 41.51830 | 2.00470 | 1.85451 | 25.2 |
| 16 | 76.30770 | Variable | | |
| 17 | 228.15550 | 2.68260 | 1.80420 | 46.5 |
| 18 | −64.61140 | 0.37310 | | |
| 19 | 42.36620 | 4.64700 | 1.43700 | 95.1 |
| 20 | −42.36620 | 0.01000 | 1.56732 | 42.8 |
| 21 | −42.36620 | 1.00000 | 2.00100 | 29.1 |
| 22 | 319.25620 | Variable | | |
| 23 (Aperture) | ∞ | 4.00000 | | |
| 24 | −172.58810 | 0.80000 | 2.00069 | 25.5 |
| 25 | 173.39690 | 0.01000 | 1.56732 | 42.8 |
| 26 | 173.39690 | 2.52070 | 1.73037 | 32.2 |
| 27 | −44.29950 | Variable | | |
| 28 | 3626.97520 | 2.83960 | 1.73037 | 32.2 |
| 29 | −26.51420 | 0.01000 | 1.56732 | 42.8 |
| 30 | −26.51420 | 0.60000 | 1.70154 | 41.1 |
| 31 | 40.39450 | Variable | | |
| 32 | 69.29630 | 4.60240 | 1.56732 | 42.8 |
| 33 | −37.00710 | 0.01000 | 1.56732 | 42.8 |
| 34 | −37.00710 | 1.12340 | 1.80610 | 33.3 |
| 35 | −55.69350 | Variable | | |
| 36 | −69.22250 | 1.20000 | 1.74400 | 44.8 |
| 37 | 30.08860 | 0.01000 | 1.56732 | 42.8 |
| 38 | 30.08860 | 3.92440 | 1.77047 | 29.7 |
| 39 | 84.90730 | Variable | | |
| 40 | ∞ | 2.10000 | 1.51680 | 64.2 |
| 41 | ∞ | 1.00000 | | |
| Image plane | ∞ | | | |

### (Table 7B: Aspheric Surface Data)

In this embodiment, there are no surfaces that are aspheric surfaces.

TABLE 7C
(Various types of data in infinity in-focus state)
(Various types of data)
Zoom ratio: 4.96198

| | Wide-angle | Middle | Telephoto |
|---|---|---|---|
| Focal length | 97.0253 | 216.2159 | 481.4376 |
| F number | 5.76950 | 7.23895 | 8.27890 |
| Angle of view | 12.4121 | 5.6241 | 2.5257 |
| Image height | 21.6300 | 21.6300 | 21.6300 |
| Total lens length | 199.9998 | 247.1544 | 278.9998 |
| d6 | 1.5000 | 48.6546 | 80.5000 |
| d16 | 40.7007 | 25.7481 | 2.6930 |
| d22 | 15.7666 | 9.5630 | 14.2579 |
| d27 | 5.6945 | 11.5683 | 2.0018 |
| d31 | 7.6258 | 22.9083 | 50.8350 |
| d35 | 45.9875 | 23.2036 | 1.8000 |
| d39 | 20.5000 | 43.2838 | 64.6874 |
| Entrance pupil position | 73.2750 | 200.7248 | 401.2941 |
| Exit pupil position | −56.0800 | −84.9614 | −120.1490 |
| Anterior principal point | 2.6001 | −132.5795 | −1047.6503 |
| Posterior principal point | 103.0298 | 31.0501 | −202.5162 |

TABLE 7D
(Data about single lenses)

| Lens | Start surface | Focal length |
|---|---|---|
| 1 | 1 | −244.6990 |
| 2 | 3 | 216.5399 |
| 3 | 5 | 174.3562 |
| 4 | 7 | 63.1981 |
| 5 | 9 | −57.5651 |
| 6 | 11 | −91.2800 |
| 7 | 13 | −71.9101 |
| 8 | 15 | 103.8163 |
| 9 | 17 | 62.8684 |
| 10 | 19 | 49.2960 |
| 11 | 21 | −37.3137 |
| 12 | 24 | −86.3359 |
| 13 | 26 | 48.5482 |
| 14 | 28 | 36.0507 |
| 15 | 30 | −22.7332 |
| 16 | 32 | 43.1996 |
| 17 | 34 | −140.6006 |
| 18 | 36 | −28.0445 |
| 19 | 38 | 58.6596 |

TABLE 7E
(Data about zoom lens groups)

| | Start | | Lens configuration | Anterior | Posterior |
|---|---|---|---|---|---|
| Group | surface | Focal length | length | principal point | principal point |
| 1 | 1 | 161.73574 | 17.09470 | 5.02403 | 10.29913 |
| 2 | 7 | −59.66757 | 11.66680 | 7.05124 | 10.78863 |
| 3 | 17 | 88.85529 | 8.71270 | −4.06444 | −0.41949 |
| 4 | 23 | 107.04016 | 7.33070 | 7.22327 | 8.73229 |
| 5 | 28 | −62.24925 | 3.44960 | 2.05242 | 3.50098 |
| 6 | 32 | 62.50711 | 5.73580 | 2.04899 | 4.15634 |
| 7 | 36 | −52.07924 | 5.13440 | 1.34125 | 3.60540 |

TABLE 7F
(Zoom powers of zoom lens groups)

| Group | Start surface | Wide-angle | Middle | Telephoto |
|---|---|---|---|---|
| 1 | 1 | 0.00000 | 0.00000 | 0.00000 |
| 2 | 7 | −0.68804 | −1.50802 | −7.72759 |
| 3 | 17 | −1.79941 | −1.06600 | −0.20597 |
| 4 | 23 | 0.33072 | 0.40439 | 0.58306 |
| 5 | 28 | −20.43948 | 5.81008 | 3.07061 |
| 6 | 32 | −0.04877 | 0.18547 | 0.45109 |
| 7 | 36 | 1.46984 | 1.90840 | 2.31574 |

### (Values Corresponding to Inequalities)

Values, corresponding to the inequalities (1) to (10), of the respective examples of numerical values are shown in the following Table 8:

TABLE 8

| Inequality | | Ex.1 | Ex.2 | Ex.3 | Ex.4 | Ex.5 | Ex.6 | Ex.7 |
|---|---|---|---|---|---|---|---|---|
| (1) | f2b/f2 | 0.994 | 1.053 | 0.937 | 1.179 | 1.041 | 0.911 | 1.073 |
| (2) | (1-−βTF × βTF) × (βTR × βTR) | −8.821 | −8.893 | −8.872 | −8.903 | −8.892 | −9.160 | −9.198 |
| (3) | BFw/fW | 0.247 | 0.235 | 0.228 | 0.228 | 0.237 | 0.214 | 0.243 |
| (4) | f1/fT | 0.362 | 0.368 | 0.365 | 0.368 | 0.371 | 0.351 | 0.336 |
| (5) | f3/f4 | 0.845 | 0.798 | 0.725 | 0.735 | 0.884 | 0.719 | 0.830 |
| (6) | f6/fT | 0.138 | 0.137 | 0.142 | 0.139 | 0.145 | 0.141 | 0.130 |
| (7) | f7/fT | −0.120 | −0.120 | −0.124 | −0.121 | −0.124 | −0.114 | −0.108 |
| (8) | nd_3Gn | 2.0509 | 2.0010 | 2.0010 | 2.0010 | 2.0010 | 2.0010 | 2.0010 |
| (9) | nd_4Gn | 2.0007 | 2.0007 | 2.0509 | 2.0509 | 2.0007 | 2.0007 | 2.0007 |
| (10) | vd_2ap | 25.2 | 25.2 | 23.8 | 23.8 | 25.2 | 25.2 | 25.2 |

While the foregoing has described what are considered to be the best mode and/or other examples, it is understood that various modifications may be made therein and that the subject matter disclosed herein may be implemented in various forms and examples, and that they may be applied in numerous applications, only some of which have been described herein. It is intended by the following claims to claim any and all modifications and variations that fall within the true scope of the present teachings.

### INDUSTRIAL APPLICABILITY

The imaging optical system according to the present disclosure is applicable to various types of cameras including digital still cameras, digital cameras, of which the lens is interchangeable, digital camcorders, cameras for cellphones and smartphones, and cameras for personal digital assistants (PDAs), surveillance cameras for surveillance systems, Web cameras, and onboard cameras. Among other things, the present disclosure is particularly suitably applicable to imaging optical systems that are required to provide high image quality such as digital still camera systems and digital camcorder systems.

1. An imaging optical system consisting of:
a first lens group having positive power;
a second lens group having negative power;
a third lens group having positive power;
a fourth lens group having positive power;
a fifth lens group having negative power;
a sixth lens group having positive power; and
a seventh lens group having negative power,
the first, second, third, fourth, fifth, sixth, and seventh lens groups being arranged in this order such that the first lens group is located closer to an object than any of the second, third, fourth, fifth, sixth, or seventh lens group is and that the seventh lens group is located closer to an image plane than any of the first, second, third, fourth, fifth, or sixth lens groups is,
an interval between each pair of lens groups located adjacent to each other which belong to the first through seventh lens groups changing while the imaging optical system is zooming from a wide-angle end toward a telephoto end, and
the second lens group and the sixth lens group being fixed with respect to the image plane.

2. The imaging optical system of claim 1, wherein
the second lens group consists of a sub-lens group G2a and a sub-lens group G2b,
the imaging optical system is configured to make image stabilization by moving the sub-lens group G2b perpendicularly to an optical axis,
the imaging optical system satisfies the following inequality (1):
$$0.8 < f 2 b / f 2 < 1.3 \qquad ( 1 )$$
where f2 is a focal length of the second lens group, and
f2b is a focal length of the sub-lens group G2b.

3. The imaging optical system of claim 1, wherein
the fifth lens group consists of a positive lens and a negative lens, the positive lens and the negative lens being arranged in this order such that the positive lens is located closer to the object than the negative lens is and that the negative lens is located closer to the image plane than the positive lens is,
the fifth lens group moves toward the image plane while the imaging optical system is focusing to make a transition from an infinity in-focus state toward a close-object in-focus state, and
the imaging optical system satisfies the following inequality (2):
$$- 11 < ( 1 - β TF \times β TF ) \times ( β TR \times β TR ) < - 7 \qquad ( 2 )$$
where βTF is a lateral magnification of the fifth lens group when the imaging optical system is in the infinity in-focus state at the telephoto end, and
βTR is a composite lateral magnification of all lens groups, located closer to the image plane than the fifth lens group is, of the imaging optical system when the imaging optical system is in the infinity in-focus state at the telephoto end.

4. The imaging optical system of claim 1, wherein
the imaging optical system satisfies the following inequality (3):
$$0.16 < BFw / fW < 0.3 \qquad ( 3 )$$
where BFw is an interval measured on an optical axis and at the wide-angle end from a lens located closest to the image plane to the image plane, and
fW is a focal length of the imaging optical system as a whole when the imaging optical system is in an infinity in-focus state at the wide-angle end.

5. The imaging optical system of claim 1, wherein
the imaging optical system satisfies the following inequality (4):
$$0.1 < f 1 / fT < 0.6 \qquad ( 4 )$$
where f1 is a focal length of the first lens group, and
fT is a focal length of the imaging optical system as a whole when the imaging optical system is in an infinity in-focus state at the telephoto end.

6. The imaging optical system of claim 1, wherein
the imaging optical system satisfies the following inequality (5):
$$0.5 < f 3 / f 4 < 1.1 \qquad ( 5 )$$
where f3 is a focal length of the third lens group, and
f4 is a focal length of the fourth lens group.

7. The imaging optical system of claim 1, wherein
the imaging optical system satisfies the following inequality (6):
$$0.08 < f 6 / fT < 0.2 \qquad ( 6 )$$
where f6 is a focal length of the sixth lens group, and
fT is a focal length of the imaging optical system as a whole when the imaging optical system is in an infinity in-focus state at the telephoto end.

8. The imaging optical system of claim 1, wherein
the seventh lens group consists of a negative lens and a positive lens, the negative lens and the positive lens being arranged in this order such that the negative lens is located closer to the object than the positive lens is and that the positive lens is located closer to the image plane than the negative lens is, and
the imaging optical system satisfies the following inequality (7):
$$- 0.18 < f 7 / fT < - 0.06 \qquad ( 7 )$$
where f7 is a focal length of the seventh lens group, and
fT is a focal length of the imaging optical system as a whole when the imaging optical system is in an infinity in-focus state at the telephoto end.

9. The imaging optical system of claim 1, wherein
the first lens group consists of a negative lens, a first positive lens, and a second positive lens, the negative lens, the first positive lens, and the second positive lens being arranged in this order such that the negative lens is located closer to the object than any one of the first and second positive lenses is and that the second positive lens is located closer to the image plane than the negative lens or the first positive lens is.

10. The imaging optical system of claim 1, wherein
the imaging optical system satisfies the following inequality (8):
$$1.85 < nd\_ 3 Gn < 2.15 \qquad ( 8 )$$
where nd_3Gn is a refractive index in response to a d-line of a negative lens belonging to the third lens group.

11. The imaging optical system of claim 1, wherein
the imaging optical system satisfies the following inequality (9):
$$1.85 < nd\_ 4 Gn < 2.15 \qquad ( 9 )$$
where nd_4Gn is a refractive index in response to a d-line of a negative lens belonging to the fourth lens group.

12. The imaging optical system of claim 2, wherein
the sub-lens group G2a consists of a positive lens and a negative lens, the positive lens and the negative lens being arranged in this order such that the positive lens is located closer to the object than the negative lens is and that the negative lens is located closer to the image plane than the positive lens is, and
the imaging optical system satisfies the following inequality (10):
$$20 < vd\_ 2 ap < 30 \qquad ( 10 )$$
where vd_2ap is an abbe number in response to a d-line of the positive lens belonging to the sub-lens group G2a.

13. An image capture device configured to transform an optical image of an object into an electrical image signal and display and/or store the electrical image signal thus transformed, the image capture device comprising:
the imaging optical system of claim 1 configured to form the optical image of the object; and
an image sensor configured to transform the optical image formed by the imaging optical system into the electrical image signal.

14. A camera system comprising:
an interchangeable lens unit including the imaging optical system of claim 1; and
a camera body including: an image sensor configured to receive an optical image of an object formed by the imaging optical system and transform the optical image into an electrical image signal; and a camera mount, the camera body being configured to be connected removably to the interchangeable lens unit via the camera mount,
the interchangeable lens unit being configured to form the optical image of the object on the image sensor.
